(19) United States
(12) Patent Application Publication
(10) Pub. No.: US 2013/0049621 A1
(43) Pub. Date: Feb. 28, 2013

(54) CIRCUITS AND METHODS FOR DRIVING LIGHT SOURCES

(71) Applicant: O2Micro Inc., Santa Clara, CA (US)

(72) Inventors: Tiesheng YAN, Chengdu (CN); Xueshang LIU, Chengdu (CN); Ching-Chuan KUO, Taipei City (TW)

(73) Assignee: O2Micro Inc., Santa Clara, CA (US)

(21) Appl. No.: 13/663,165

(22) Filed: Oct. 29, 2012

Related U.S. Application Data
(63) Continuation-in-part of application No. 13/608,273, filed on Sep. 10, 2012.
Application No. 13/608,273 is a continuation-in-part of application No. 13/530,935, filed on Jun. 22, 2012.
Application No. 13/530,935 is a continuation-in-part of application No. 13/371,351, filed on Feb. 10, 2012.
Application No. 13/371,351 is a continuation-in-part of application No. 12/761,681, filed on Apr. 16, 2010, now Pat. No. 8,339,063.

(30) Foreign Application Priority Data
Mar. 4, 2010 (CN) 201010119888.2
Dec. 29, 2011 (CN) 201110453588.2
May 11, 2012 (CN) 201210148065.1
Sep. 28, 2012 (CN) 201210369122.9

(51) Int. Cl. H05B 37/02

(52) U.S. Cl. 315/205

(57) ABSTRACT

A driving circuit includes a converter, a transformer, a first sensor and a second sensor. The converter is coupled to a switch that operates in a first state or in a second state. The converter receives an input voltage and provides a regulated voltage. The transformer transforms the regulated voltage to an output voltage to power said LED light source. Both a first current through the converter and a second current through the transformer further flow through the switch when the switch operates in the first state. The first sensor coupled between the switch and a first reference node provides a first sense signal indicating a combined current of the first current and the second current. The second sensor coupled between the first reference node and a second reference node provides a second sense signal indicating only the second current.

### RELATED APPLICATIONS

This application is a continuation-in-part of the co-pending U.S. application Ser. No. 13/530,935, titled “Circuits and Methods for Driving Light Sources,” filed on Jun. 22, 2012, which itself is a continuation-in-part of the co-pending U.S. application Ser. No. 13/371,351, titled “Circuits and Methods for Driving Light Sources,” filed on Feb. 10, 2012, which itself is a continuation-in-part of the co-pending U.S. application Ser. No. 12/761,681, titled “Circuits and Methods for Driving Light Sources,” filed on Apr. 16, 2010, which itself claims priority to Chinese Patent Application No. 201010119888.2, titled “Circuits and Methods for Driving Light Sources,” filed on Mar. 4, 2010, with the State Intellectual Property Office of the People's Republic of China, all of which are incorporated by reference. The application with Ser. No. 13/371,351 also claims priority to Chinese Patent Application No. 201110453588.2, titled “Circuit, Method and Controller for Driving LED Light Source,” filed on Dec. 29, 2011, with the State Intellectual Property Office of the People's Republic of China, incorporated by reference. This application is also a continuation-in-part of the co-pending U.S. application Ser. No. 13/608,273, titled “Circuits and Methods for Driving Light Sources,” filed on Sep. 10, 2012, which itself claims priority to Chinese Patent Application No. 201210148065.1, titled “Circuits and Methods for Driving Light Sources,” filed on May 11, 2012, with the State Intellectual Property Office of the People's Republic of China, which are incorporated by reference. This application also claims priority to Chinese Patent Application No. 201210369122.9, titled “Circuits and Methods for Driving Light Sources,” filed on Sep. 28, 2012, with the State Intellectual Property Office of the People's Republic of China, which are incorporated by reference.

### BACKGROUND

FIG. 1 shows a block diagram of a conventional circuit 100 for driving a light source, e.g., a light emitting diode (LED) string 108. The circuit 100 is powered by a power source 102 which provides an input voltage VIN. The circuit 100 includes a buck converter for providing a regulated voltage VOUT to an LED string 108 under control of a controller 104. The buck converter includes a diode 114, an inductor 112, a capacitor 116, and a switch 106. A resistor 110 is coupled in series with the switch 106. When the switch 106 is turned on, the resistor 110 is coupled to the inductor 112 and the LED string 108, and can provide a feedback signal indicative of a current flowing through the inductor 112. When the switch 106 is turned off, the resistor 110 is disconnected from the inductor 112 and the LED string 108, and thus no current flows through the resistor 110.

The switch 106 is controlled by the controller 104. When the switch 106 is turned on, a current flows through the LED string 108, the inductor 112, the switch 106, and the resistor 110 to ground. The current increases due to the inductance of the inductor 112. When the current reaches a predetermined peak current level, the controller 104 turns off the switch 106. When the switch 106 is turned off, a current flows through the LED string 108, the inductor 112, and the diode 114. The controller 104 can turn on the switch 106 again after a time period. Thus, the controller 104 controls the buck converter based on the predetermined peak current level. However, the average level of the current flowing through the inductor 112 and the LED string 108 can vary with the inductance of the inductor 112, the input voltage VIN, and the voltage VOUT across the LED string 108. Therefore, the average level of the current flowing through the inductor 112 (the average current flowing through the LED string 108) may not be accurately controlled.

### SUMMARY

In one embodiment, a driving circuit for driving a load, e.g., an LED light source, includes a converter, a transformer, a first sensor and a second sensor. The converter is coupled to a switch that operates in a first state or a second state. The converter is configured to receive an input voltage and provide a regulated voltage. The transformer is coupled to the converter and the switch, and is configured to transform the regulated voltage to an output voltage to power the LED light source. Both a first current through the converter and a second current through the transformer further flow through the switch when the switch operates in the first state. The first sensor is coupled between the switch and a first reference node, and is configured to provide a first sense signal indicating a combined current of the first current and the second current. The second sensor is coupled between the first reference node and a second reference node, and is configured to provide a second sense signal indicating only the second current.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a conventional circuit for driving a light source.

FIG. 2 shows a block diagram of a driving circuit, in an embodiment according to the present invention.

FIG. 3 shows an example of a schematic diagram of a driving circuit, in an embodiment according to the present invention.

FIG. 4 shows an example of a controller, in an embodiment according to the present invention.

FIG. 5 shows waveforms of signals associated with a controller, in an embodiment according to the present invention.

FIG. 6 shows another example of the controller, in an embodiment according to the present invention.

FIG. 7 shows waveforms of signals associated with a controller, in an embodiment according to the present invention.

FIG. 8 shows another example of a schematic diagram of a driving circuit, in an embodiment according to the present invention.

FIG. 9A shows another block diagram of a driving circuit, in an embodiment according to the present invention.

FIG. 9B shows an example of waveforms of signals generated or received by a driving circuit, in an embodiment according to the present invention.

FIG. 10 shows an example of a schematic diagram of a driving circuit, in an embodiment according to the present invention.

FIG. 11 shows an example of a controller, in an embodiment according to the present invention.

FIG. 12 illustrates waveforms of signals generated or received by a driving circuit, in an embodiment according to the present invention.

FIG. 13 illustrates a flowchart of operations performed by a circuit for driving a load, in an embodiment according to the present invention.

FIG. 14A shows another block diagram of a driving circuit in an embodiment according to the present invention.

FIG. 14B illustrates other waveforms of signals generated or received by a driving circuit, in an embodiment according to the present invention.

FIG. 15 shows an example schematic diagram of a driving circuit, in an embodiment according to the present invention.

FIG. 16 shows an example of a controller in an embodiment according to the present invention.

FIG. 17 illustrates a flowchart of examples of operations performed by a circuit for driving a light source, in an embodiment according to the present invention.

FIG. 18A illustrates another example of a diagram of a driving circuit, in an embodiment according to the present invention.

FIG. 18B illustrates other waveforms of signals generated or received by a driving circuit, in an embodiment according to the present invention.

FIG. 19 illustrates other waveforms of signals generated or received by a driving circuit, in an embodiment according to the present invention.

FIG. 20 illustrates another example of a controller, in an embodiment according to the present invention.

FIG. 21 illustrates other waveforms of signals generated or received by a controller, in an embodiment according to the present invention.

FIG. 22 illustrates a block diagram of an electronic system, in an embodiment according to the present invention.

FIG. 23 illustrates waveforms of signals generated or received by a triode for alternating current (TRIAC) dimmer, in an embodiment according to the present invention.

FIG. 24 illustrates an example of a driving circuit, in an embodiment according to the present invention.

FIG. 25 illustrates an example of a controller, in an embodiment according to the present invention.

FIG. 26 illustrates an example of a TRIAC detector, in an embodiment according to the present invention.

FIG. 27 illustrates a flowchart of examples of operations performed by a driving circuit for controlling power to a light source, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide circuits and methods for controlling power converters that can be used to power various types of loads, for example, a light source. In one embodiment, the circuit can include a current sensor operable for monitoring a current flowing through an energy storage element, e.g., an inductor, and include a controller operable for controlling a switch coupled to the inductor so as to control an average current of the light source to a target current. The current sensor can monitor the current through the inductor when the switch is on and also when the switch is off.

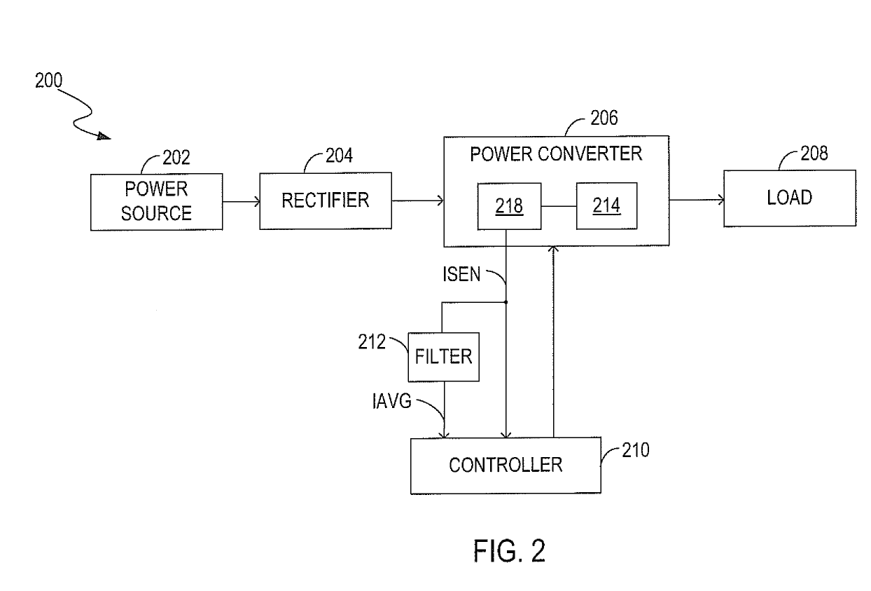

FIG. 2 shows a block diagram of a driving circuit 200, in an embodiment according to the present invention. The driving circuit 200 includes a rectifier 204 which receives an input voltage from a power source 202 and provides a rectified voltage to a power converter 206. The power converter 206, receiving the rectified voltage, provides output power for a load 208. The power converter 206 can be a buck converter or a boost converter. In one embodiment, the power converter 206 includes an energy storage element 214 and a current sensor 218 for sensing an electrical condition of the energy storage element 214. The current sensor 218 provides a first signal ISEN to a controller 210, which indicates an instant current flowing through the energy storage element 214. The driving circuit 200 can further include a filter 212 operable for generating a second signal IAVG based on the first signal ISEN, which indicates an average current flowing through the energy storage element 214. The controller 210 receives the first signal ISEN and the second signal IAVG, and controls the average current flowing through the energy storage element 214 to a target current level, in one embodiment.

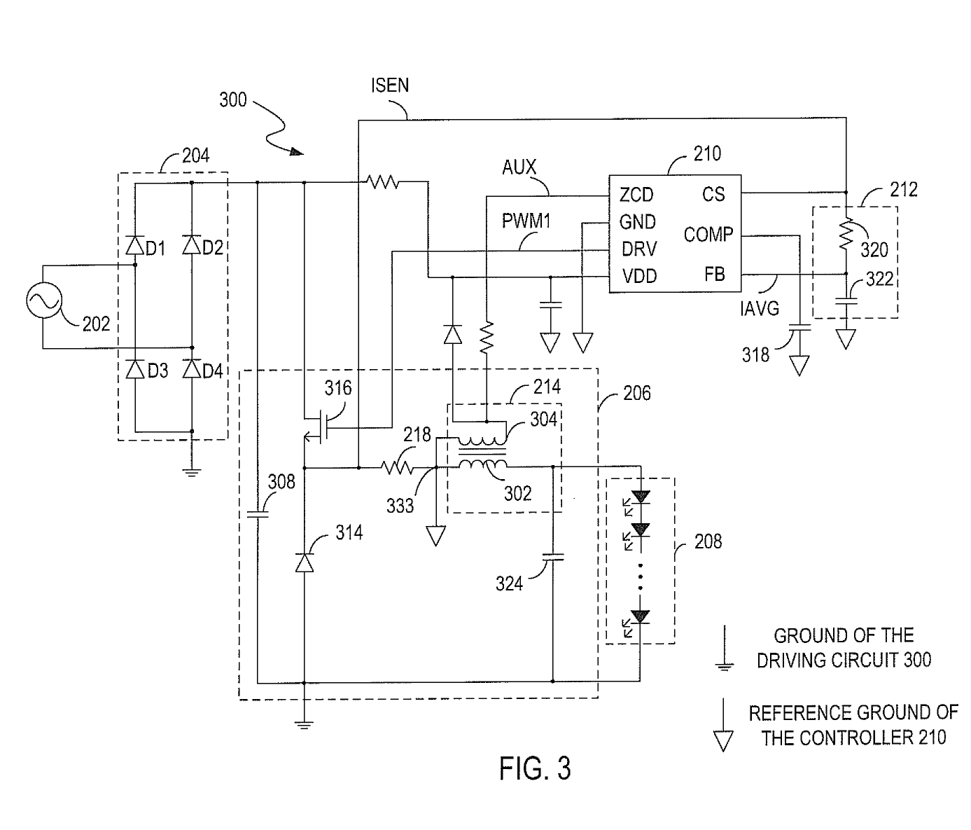

FIG. 3 shows an example for a schematic diagram of a driving circuit 300, in an embodiment according to the present invention. Elements labeled the same as in FIG. 2 have similar functions. In the example of FIG. 3, the driving circuit 300 includes a rectifier 204, a power converter 206, a filter 212, and a controller 210. By way of example, the rectifier 204 is a bridge rectifier which includes diodes D1˜D4. The rectifier 204 rectifies the voltage from the power source 202. The power converter 206 receives the rectified voltage from the rectifier 204 and provides output power for powering a load, e.g., an LED string 208.

In the example of FIG. 3, the power converter 206 is a buck converter including a capacitor 308, a switch 316, a diode 314, a current sensor 218 (e.g., a resistor), coupled inductors 302 and 304, and a capacitor 324. The diode 314 is coupled between the switch 316 and ground of the driving circuit 300. The capacitor 324 is coupled in parallel with the LED string 208. In one embodiment, the inductors 302 and 304 are both electrically and magnetically coupled together. More specifically, the inductor 302 and the inductor 304 are electrically coupled to a common node 333. In the example of FIG. 3, the common node 333 is between the resistor 218 and the inductor 302. However, the invention is not so limited; the common node 333 can also be located between the switch 316 and the resistor 218. The common node 333 provides a reference ground for the controller 210. The reference ground of the controller 210 is different from the ground of the driving circuit 300, in one embodiment. By turning the switch 316 on and off, a current flowing through the inductor 302 can be adjusted, thereby adjusting the power provided to the LED string 208. The inductor 304 senses an electrical condition of the inductor 302, for example, whether the current flowing through the inductor 302 decreases to a predetermined current level.

The resistor 218 has one end coupled to a node between the switch 316 and the cathode of the diode 314, and the other end coupled to the inductor 302. The resistor 218 provides a first signal ISEN indicating an instant current flowing through the inductor 302 when the switch 316 is on and also when the switch 316 is off. In other words, the resistor 218 can sense the instant current flowing through the inductor 302 regardless of whether the switch 316 is on or off. The filter 212 coupled to the resistor 218 generates a second signal IAVG indicating an average current flowing through the inductor 302. In one embodiment, the filter 212 includes a resistor 320 and a capacitor 322.

The controller 210 receives the first signal ISEN and the second signal IAVG, and controls an average current flowing through the inductor 302 to a target current level by turning the switch 316 on and off. A capacitor 324 absorbs ripple current flowing through the LED string 208 such that the current flowing through the LED string 208 is smoothed and substantially equal to the average current flowing through the inductor 302. As such, the current flowing through the LED string 208 can have a level that is substantially equal to the target current level. As used herein, “substantially equal to the target current level” means that the current flowing through the LED string 208 may be slightly different from the target current level but within a range such that the current ripple caused by the non-ideality of the circuit components can be neglected and the power transferred from the inductor 304 to the controller 210 can be neglected.

In the example of FIG. 3, the controller 210 has terminals ZCD, GND, DRV, VDD, CS, COMP, and FB. The terminal ZCD is coupled to the inductor 304 for receiving a detection signal AUX indicating an electrical condition of the inductor 302, for example, whether the current flowing through the inductor 302 decreases to a predetermined current level, e.g., zero. The signal AUX can also indicate whether the LED string 208 is in an open circuit condition. The terminal DRV is coupled to the switch 316 and generates a driving signal, e.g., a pulse-width modulation signal PWM1, to turn the switch 316 on and off. The terminal VDD is coupled to the inductor 304 for receiving power from the inductor 304. The terminal CS is coupled to the resistor 218 and is operable for receiving the first signal ISEN indicating an instant current flowing through the inductor 302. The terminal COMP is coupled to the reference ground of the controller 210 through a capacitor 318. The terminal FB is coupled to the resistor 218 through the filter 212 and is operable for receiving the second signal IAVG which indicates an average current flowing through the inductor 302. In the example of FIG. 3, the terminal GND, that is, the reference ground for the controller 210, is coupled to the common node 333 between the resistor 218, the inductor 302, and the inductor 304.

The switch 316 can be an N channel metal oxide semiconductor field effect transistor (NMOSFET). The conductance status of the switch 316 is determined based on a difference between the gate voltage of the switch 316 and the voltage at the terminal GND (the voltage at the common node 333). Therefore, the switch 316 is turned on and turned off depending upon the pulse-width modulation signal PWM1 from the terminal DRV. When the switch 316 is on, the reference ground of the controller 210 is higher than the ground of the driving circuit 300, making the circuit suitable for power sources having relatively high voltages.

In operation, when the switch 316 is turned on, a current flows through the switch 316, the resistor 218, the inductor 302, and the LED string 208 to the ground of the driving circuit 300. When the switch 316 is turned off, a current continues to flow through the resistor 218, the inductor 302, the LED string 208, and the diode 314. The inductor 304 (magnetically coupled to the inductor 302) detects an electrical condition of the inductor 302, for example, whether the current flowing through the inductor 302 decreases to a predetermined current level. Therefore, the controller 210 monitors the current flowing through the inductor 302 through the signal AUX, the signal ISEN, and the signal IAVG, and controls the switch 316 by a pulse-width modulation signal PWM1 so as to control an average current flowing through the inductor 302 at a target current level, in one embodiment. As such, the current flowing through the LED string 208, which is filtered by the capacitor 324, can also be substantially equal to the target current level.

In one embodiment, the controller 210 determines whether the LED string 208 is in an open circuit condition based on the signal AUX. If the LED string 208 is open, the voltage across the capacitor 324 increases. When the switch 316 is off, the voltage across the inductor 302 increases and the voltage of the signal AUX increases accordingly. As a result, the current flowing through the terminal ZCD into the controller 210 increases. Therefore, the controller 210 monitors the signal AUX and, if the current flowing into the controller 210 increases above a current threshold when the switch 316 is off, then the controller 210 determines that the LED string 208 is in an open circuit condition.

The controller 210 can also determine whether the LED string 208 is in a short circuit condition based on the voltage at the terminal VDD. If the LED string 208 is in a short circuit condition, then when the switch 316 is off, the voltage across the inductor 302 decreases because both terminals of the inductor 302 are coupled to ground of the driving circuit 300. The voltage across the inductor 304 and the voltage at the terminal VDD decrease accordingly. If the voltage at the terminal VDD decreases below a voltage threshold when the switch 316 is off, the controller 210 determines that the LED string 208 is in a short circuit condition.

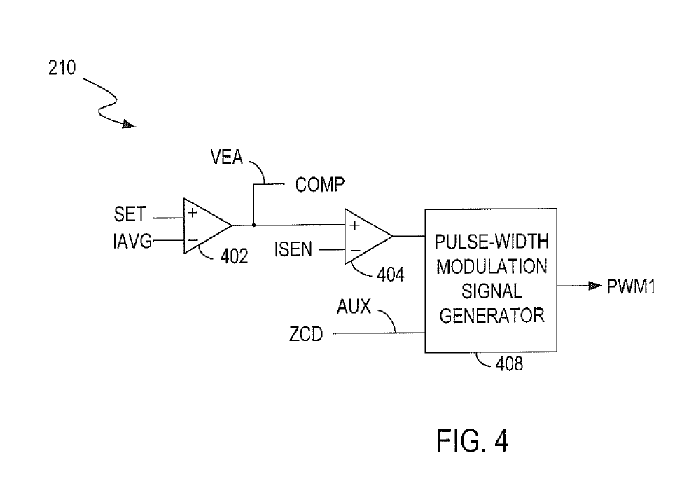

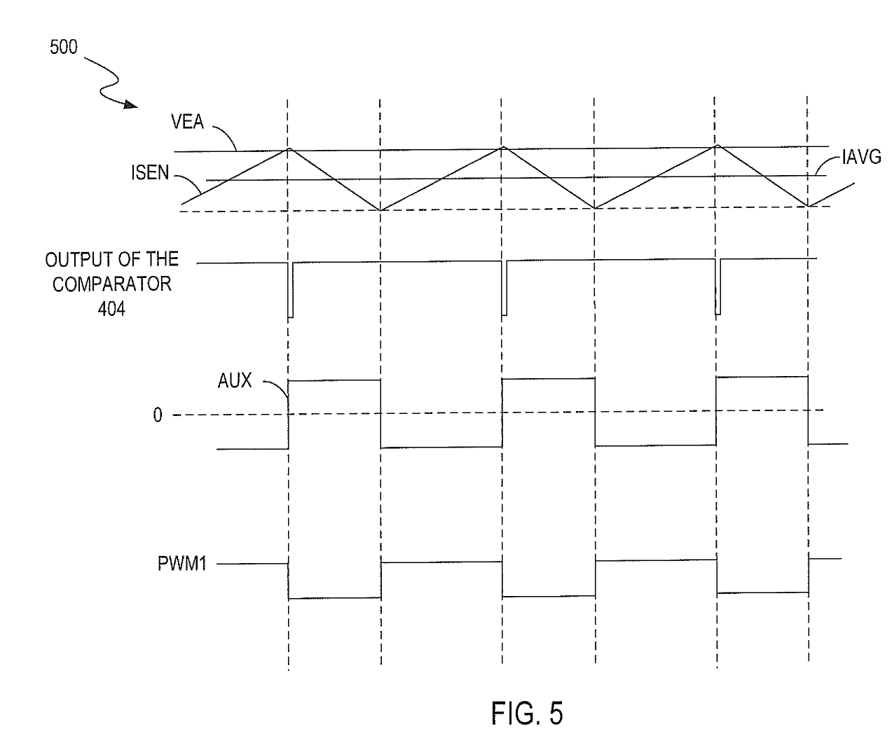

FIG. 4 shows an example of the controller 210 in FIG. 3, in an embodiment according to the present invention. FIG. 5 shows waveforms of signals associated with the controller 210 in FIG. 4, in an embodiment according to the present invention. FIG. 4 is described in combination with FIG. 3 and FIG. 5.

In the example of FIG. 4, the controller 210 includes an error amplifier 402, a comparator 404, and a pulse-width modulation signal generator 408. The error amplifier 402 generates an error signal VEA based on a difference between a reference signal SET and the signal IAVG. The reference signal SET can indicate a target current level. The signal IAVG is received at the terminal FB and can indicate an average current flowing through the inductor 302. The error signal VEA can be used to adjust the average current flowing through the inductor 302 to the target current level. The comparator 404 is coupled to the error amplifier 402 and compares the error signal VEA with the signal ISEN. The signal ISEN is received at the terminal CS and indicates an instant current flowing through the inductor 302. The signal AUX is received at the terminal ZCD and indicates whether the current flowing through the inductor 302 decreases to a predetermined current level, e.g., zero. The pulse-width modulation signal generator 408 is coupled to the comparator 404 and the terminal ZCD, and can generate a pulse-width modulation signal PWM1 based on an output of the comparator 404 and the signal AUX. The pulse-width modulation signal PWM1 is applied to the switch 316 via the terminal DRV to control a conductance status of the switch 316.

In operation, the pulse-width modulation signal generator 408 can generate the pulse-width modulation signal PWM1 having a first level (e.g., logic 1) to turn on the switch 316. When the switch 316 is turned on, a current flows through the switch 316, the resistor 218, the inductor 302, and the LED string 208 to the ground of the driving circuit 300. The current flowing through the inductor 302 increases such that the voltage of the signal ISEN increases. The signal AUX has a negative voltage level when the switch 316 is turned on, in one embodiment. In the controller 210, the comparator 404 compares the error signal VEA with the signal ISEN. When the voltage of the signal ISEN increases above the voltage of the error signal VEA, then the output of the comparator 404 is logic 0, and otherwise the output of the comparator 404 is logic 1, in one embodiment. In other words, the output of the comparator 404 includes a series of pulses. The pulse-width modulation signal generator 408 generates the pulse-width modulation signal PWM1 having a second level (e.g., logic 0) in response to a negative-going edge of the output of the comparator 404 to turn off the switch 316. The voltage of the signal AUX changes to a positive voltage level when the switch 316 is turned off. When the switch 316 is turned off, a current flows through the resistor 218, the inductor 302, the LED string 208, and the diode 314. The current flowing through the inductor 302 decreases such that the voltage of the signal ISEN decreases. When the current flowing through the inductor 302 decreases to a predetermined current level (e.g., zero), a negative-going edge occurs to the voltage of the signal AUX. Receiving a negative-going edge of the signal AUX, the pulse-width modulation signal generator 408 generates the pulse-width modulation signal PWM1 having the first level (e.g., logic 1) to turn on the switch 316.

In one embodiment, a duty cycle of the pulse-width modulation signal PWM1 is determined by the error signal VEA. If the voltage of the signal IAVG is less than the voltage of the signal SET, the error amplifier 402 increases the voltage of the error signal VEA so as to increase the duty cycle of the pulse-width modulation signal PWM1. Accordingly, the average current flowing through the inductor 302 increases until the voltage of the signal IAVG reaches the voltage of the signal SET. If the voltage of the signal IAVG is greater than the voltage of the signal SET, the error amplifier 402 decreases the voltage of the error signal VEA so as to decrease the duty cycle of the pulse-width modulation signal PWM1. Accordingly, the average current flowing through the inductor 302 decreases until the voltage of the signal IAVG drops to the voltage of the signal SET. As such, the average current flowing through the inductor 302 can be maintained to be substantially equal to the target current level.

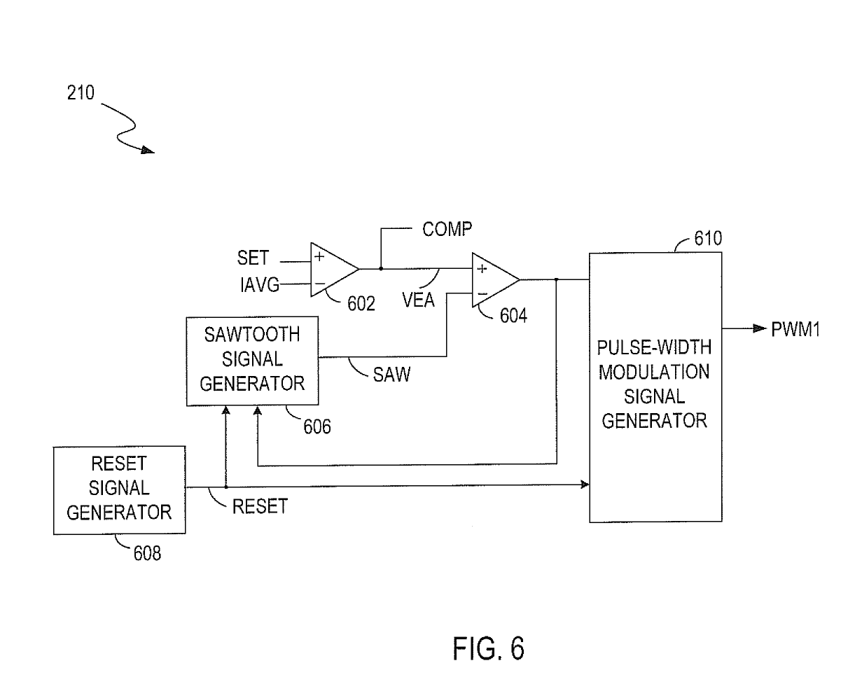

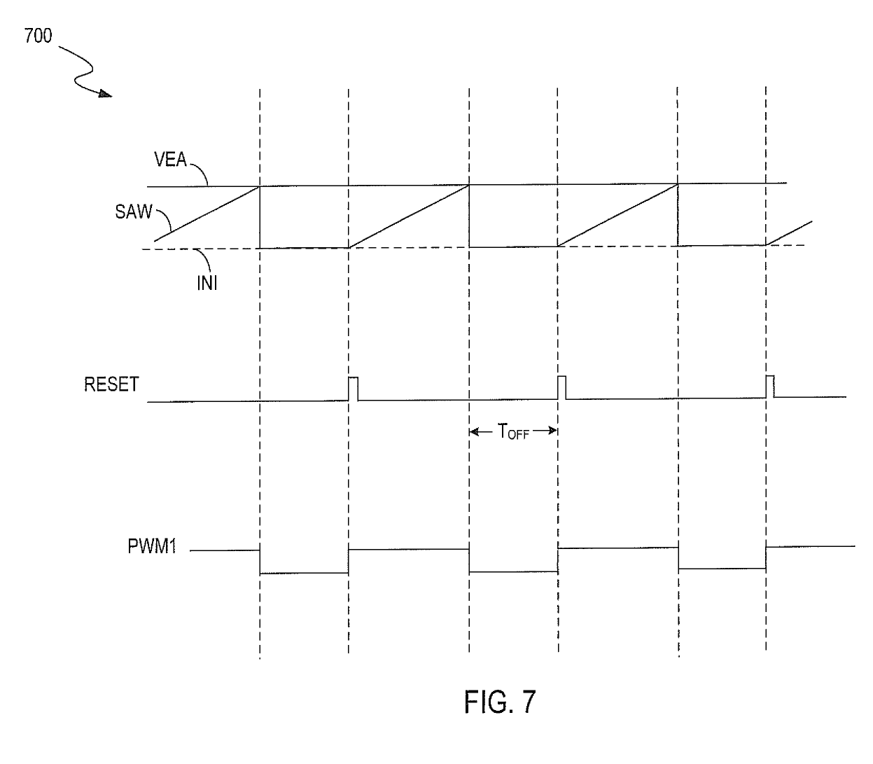

FIG. 6 shows another example of the controller 210 in FIG. 3, in an embodiment according to the present invention. FIG. 7 shows waveforms of signals associated with the controller 210 in FIG. 6, in an embodiment according to the present invention. FIG. 6 is described in combination with FIG. 3 and FIG. 7.

In the example of FIG. 6, the controller 210 includes an error amplifier 602, a comparator 604, a saw-tooth signal generator 606, a reset signal generator 608, and a pulse-width modulation signal generator 610. The error amplifier 602 generates an error signal VEA based on a reference signal SET and the signal IAVG. The reference signal SET indicates a target current level. The signal IAVG is received at the terminal FB and indicates an average current flowing through the inductor 302. The error signal VEA is used to adjust the average current flowing through the inductor 302 to the target current level. The saw-tooth signal generator 606 generates a saw-tooth signal SAW. The comparator 604 is coupled to the error amplifier 602 and the saw-tooth signal generator 606, and compares the error signal VEA with the saw-tooth signal SAW. The reset signal generator 608 generates a reset signal RESET which is applied to the saw-tooth signal generator 606 and the pulse-width modulation signal generator 610. The switch 316 can be turned on in response to the reset signal RESET. The pulse-width modulation signal generator 610 is coupled to the comparator 604 and the reset signal generator 608, and generates a pulse-width modulation (PWM) signal PWM1 based on an output of the comparator 604 and the reset signal RESET. The pulse-width modulation signal PWM1 is applied to the switch 316 via the terminal DRV to control a conductance status of the switch 316.

In one embodiment, the reset signal RESET is a pulse signal having a constant frequency. In another embodiment, the reset signal RESET is a pulse signal configured in a way such that a time period Toff during which the switch 316 is off is constant. For example, in FIG. 5, the time period during which the pulse-width modulation signal PWM1 is logic 0 can be constant.

In operation, the pulse-width modulation signal generator 610 generates the pulse-width modulation signal PWM1 having a first level (e.g., logic 1) to turn on the switch 316 in response to a pulse of the reset signal RESET. When the switch 316 is turned on, a current flows through the switch 316, the resistor 218, the inductor 302, and the LED string 208 to the ground of the driving circuit 300. The saw-tooth signal SAW generated by the saw-tooth signal generator 606 starts to increase from an initial level INI in response to a pulse of the reset signal RESET. When the voltage of the saw-tooth signal SAW increases to the voltage of the error signal VEA, the pulse-width modulation signal generator 610 generates the pulse-width modulation signal PWM1 having a second level (e.g., logic 0) to turn off the switch 316. The saw-tooth signal SAW is reset to the initial level INI until a next pulse of the reset signal RESET is received by the saw-tooth signal generator 606. The saw-tooth signal SAW starts to increase from the initial level INI again in response to the next pulse.

In one embodiment, a duty cycle of the pulse-width modulation signal PWM1 is determined by the error signal VEA. If the voltage of the signal IAVG is less than the voltage of the signal SET, the error amplifier 602 increases the voltage of the error signal VEA so as to increase the duty cycle of the pulse-width modulation signal PWM1. Accordingly, the average current flowing through the inductor 302 increases until the voltage of the signal IAVG reaches the voltage of the signal SET. If the voltage of the signal IAVG is greater than the voltage of the signal SET, the error amplifier 602 decreases the voltage of the error signal VEA so as to decrease the duty cycle of the pulse-width modulation signal PWM1. Accordingly, the average current flowing through the inductor 302 decreases until the voltage of the signal IAVG drops to the voltage of the signal SET. As such, the average current flowing through the inductor 302 can be maintained to be substantially equal to the target current level.

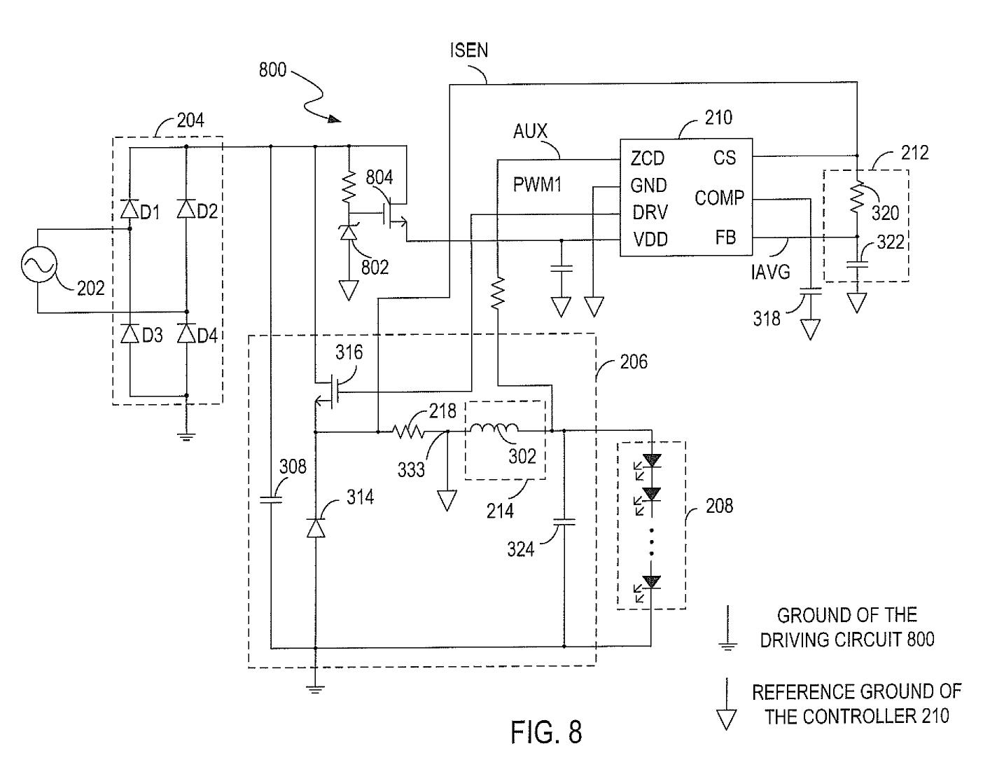

FIG. 8 shows another example for a schematic diagram of a driving circuit 800, in an embodiment according to the present invention. Elements labeled the same as in FIG. 2 and FIG. 3 have similar functions.

The terminal VDD of the controller 210 is coupled to the rectifier 204 through a switch 804 for receiving the rectified voltage from the rectifier 204. A Zener diode 802 is coupled between the switch 804 and the reference ground of the controller 210, and maintains the voltage at the terminal VDD at a substantially constant level. In the example of FIG. 8, the terminal ZCD of the controller 210 is electrically coupled to the inductor 302 for receiving a signal AUX indicating an electrical condition of the inductor 302, e.g., whether the current flowing through the inductor 302 decreases to a predetermined current level, e.g., zero. The node 333 can provide the reference ground for the controller 210.

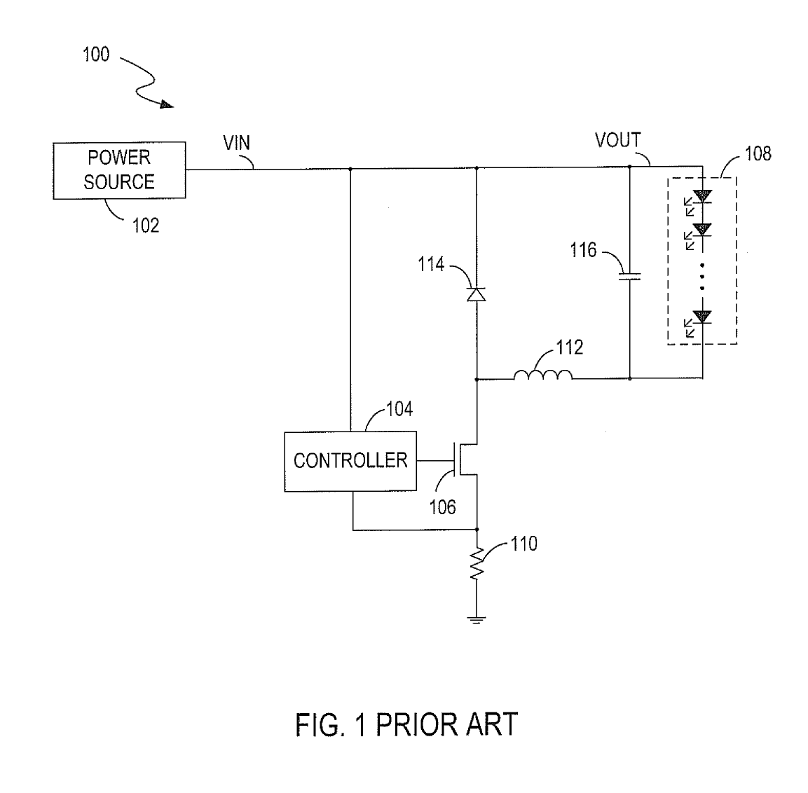

Accordingly, embodiments in accordance with the present invention provide circuits and methods for controlling a power converter that can be used to power various types of loads. In one embodiment, the power converter provides a substantially constant current to power a load such as a light emitting diode (LED) string. In another embodiment, the power converter provides a substantially constant current to charge a battery. Advantageously, compared with the conventional driving circuit in FIG. 1, the average current to the load or the battery can be controlled more accurately. Furthermore, the circuits according to present invention can be suitable for power sources having relatively high voltages.

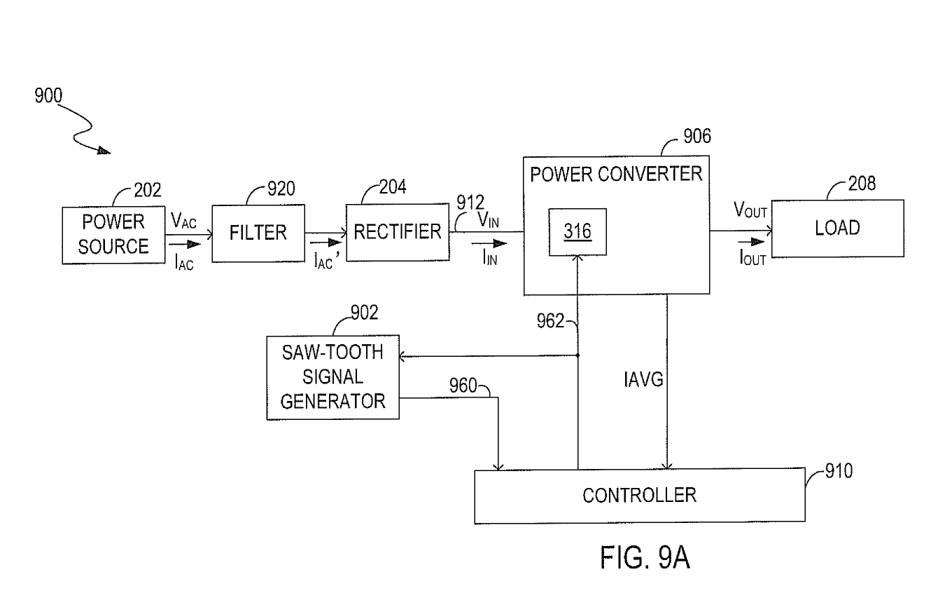

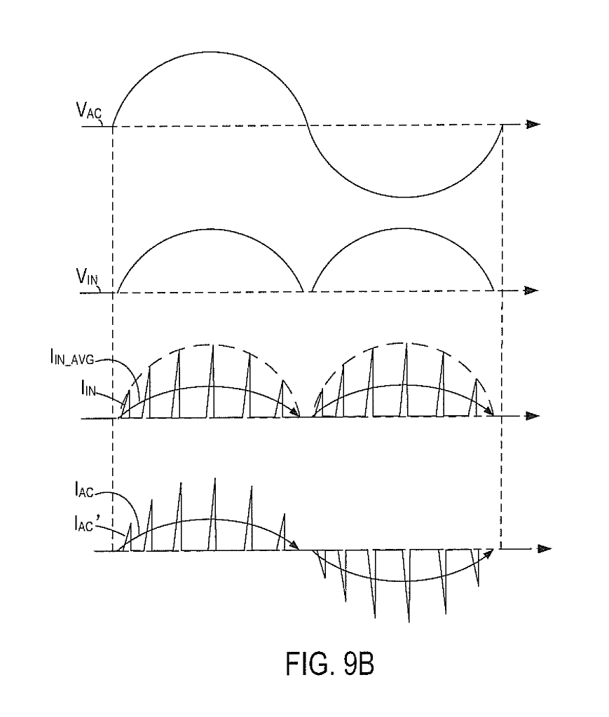

FIG. 9A shows another block diagram of a driving circuit 900, in an embodiment according to the present invention. Elements labeled the same as in FIG. 2 and FIG. 3 have similar functions. In the example of FIG. 9A, the driving circuit 900 includes a current filter 920 coupled to a power source 202, a rectifier 204, a power converter 906, a load 208, a saw-tooth signal generator 902, and a controller 910. The power source 202 generates an AC input voltage V_{AC}, e.g., having a sinusoidal waveform, and an AC input current I_{AC}. The AC input current I_{AC} flows into the current filter 920 and a current I_{AC}′ flows from the current filter 920 to the rectifier 204. The rectifier 204 receives the AC input voltage V_{AC} via the current filter 920 and provides a rectified AC voltage V_{IN} and a rectified AC current I_{IN} at the power line 912 coupled between the rectifier 204 and the power converter 906. The power converter 906 converts the voltage V_{IN} to an output voltage V_{OUT} to power the load 208. The controller 910 coupled to the power converter 906 controls the power converter 906 to regulate a current I_{OUT} through the load 208 and correct a power factor of the driving circuit 900.

The controller 910 generates a driving signal 962. In one embodiment, the power converter 906 includes a switch 316 which is controlled by the driving signal 962. As such, a current I_{OUT} flowing through the load 208 is regulated according to the driving signal 962. In one embodiment, the power converter 906 further generates a sense signal IAVG indicating the current I_{OUT} through the load 208.

In one embodiment, the saw-tooth signal generator 902 coupled to the controller 910 generates a saw-tooth signal 960 according to the driving signal 962. For example, the driving signal 962 can be a pulse-width modulation (PWM) signal. In one embodiment, when the driving signal 962 is logic high, the saw-tooth signal 960 is increased; when the driving signal 962 is logic low, the saw-tooth signal 960 drops to a predetermined voltage level, e.g., zero volt.

Advantageously, the controller 910 generates the driving signal 962 based on signals including the saw-tooth signal 960 and the sense signal IAVG. The driving signal 962 controls the switch 316 to maintain the current I_{OUT} through the load 208 at a target level, which improves the accuracy of the current control. In addition, the driving signal 962 controls the switch 316 to adjust an average current I_{IN}_{_{—}}_{AVG} of the current I_{IN} to be substantially in phase with the input voltage V_{IN}, which corrects a power factor of the driving circuit 900. The operation of the driving circuit 900 is further described in FIG. 9B.

FIG. 9B shows an example of waveforms of signals associated with the driving circuit 900 in FIG. 9A, in an embodiment according to the present invention. FIG. 9B is described in combination with FIG. 9A. FIG. 9B shows the input AC voltage V_{AC}, the rectified AC voltage V_{IN}, the rectified AC current I_{IN}, the current I_{AC}′, and the input AC current I_{AC}.

For illustrative purposes but not limitation, the input AC voltage V_{AC} has a sinusoidal waveform. The rectifier 204 rectifies the input AC voltage V_{AC}. In the example of FIG. 9B, the rectified AC voltage V_{IN} has a rectified sinusoidal waveform, in which positive waves of the input AC voltage V_{AC} remain and negative waves of the input AC voltage V_{AC} are converted to corresponding positive waves.

In one embodiment, the driving signal 962 generated by the controller 910 controls the current I_{IN}. In one embodiment, the current I_{IN} increases from a predetermined level, e.g., zero ampere. After the current I_{IN} reaches a level proportional to the rectified input AC voltage V_{IN}, the current I_{IN} drops to the predetermined level. Thus, as shown in FIG. 9B, the waveform of the average current I_{IN}_{_{—}}_{AVG} of the current I_{N} is substantially in phase with the waveform of the rectified AC voltage V_{IN}.

The current I_{IN} flowing from the rectifier 204 to the power converter 906 is a rectified current of the current I_{AC}′ flowing into the rectifier 204. As shown in FIG. 9B, the current I_{AC}′ has positive waves similar to those of the current I_{IN} when the input AC voltage V_{AC} is positive and has negative waves corresponding to those of the current I_{IN} when the input AC voltage V_{AC} is negative.

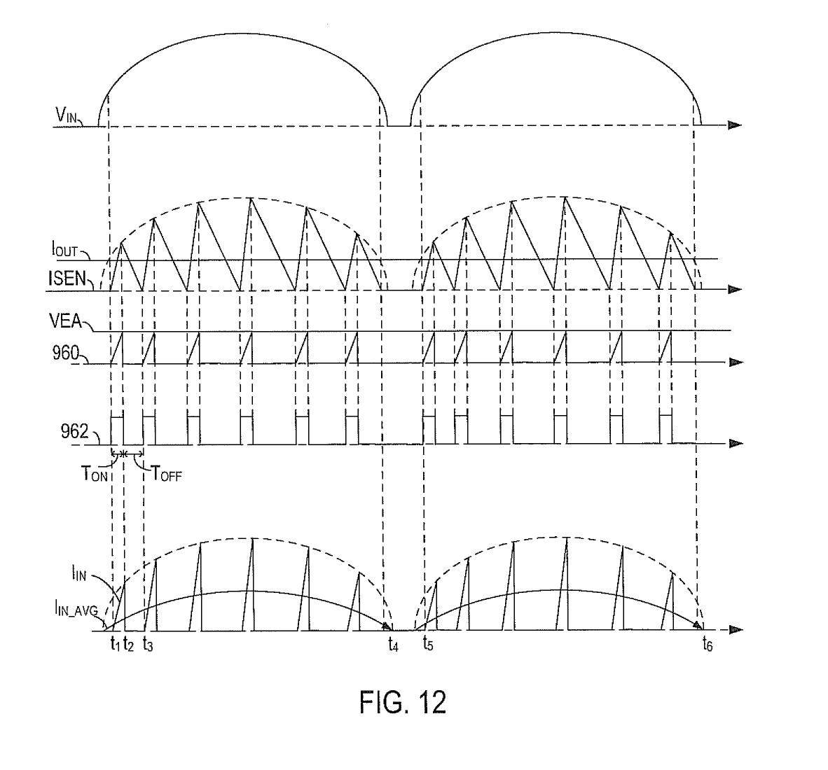

In one embodiment, by employing a current filter 920 between the power source 202 and the rectifier 204, the input AC current I_{AC} is equal to or proportional to an average current of the current I_{AC}′. Therefore, as shown in FIG. 12, the waveform of the input AC current I_{AC} is substantially in phase with the waveform of the input AC voltage V_{AC}. Ideally, the AC input voltage V_{AC} and the AC input current I_{AC} are in phase. However, in practical application, there might be a slight phase difference due to capacitors in the current filter 920 and the power converter 906. Moreover, the shape of the waveform of the input AC current I_{AC} is similar to the shape of the waveform of the input AC voltage V_{AC}. Therefore, a power factor of the driving circuit 900 is corrected, which improves the power quality of the driving circuit 900.

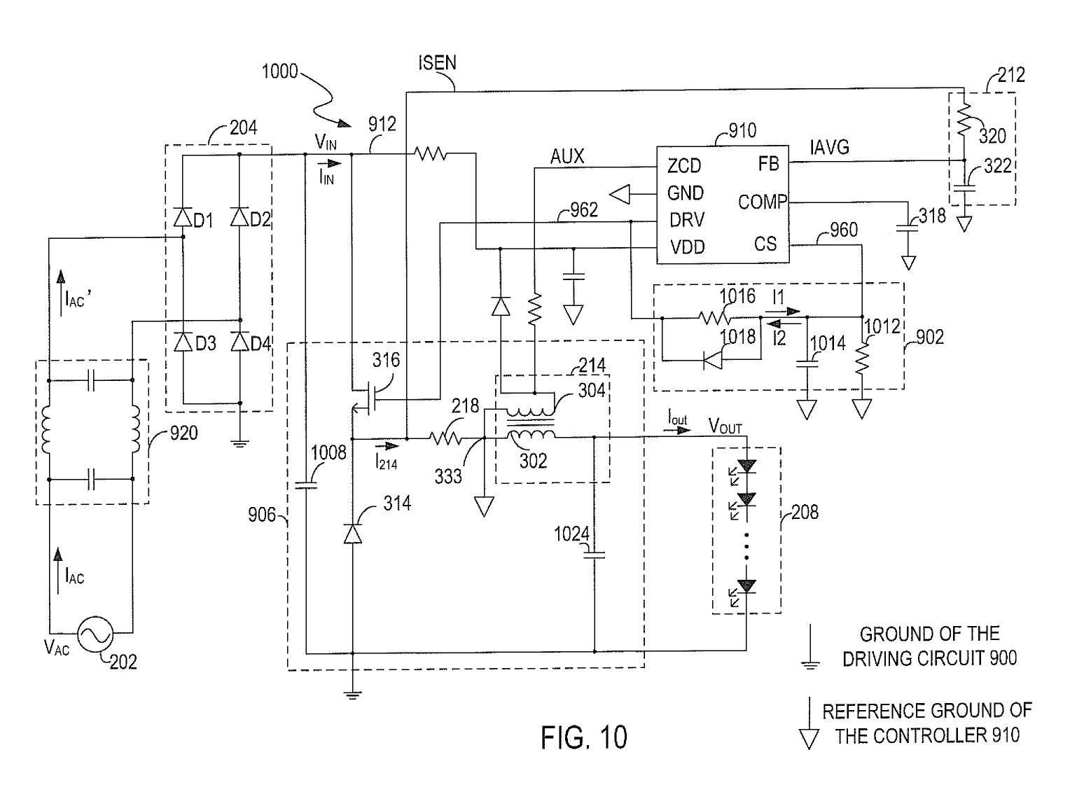

FIG. 10 shows an example for a schematic diagram of a driving circuit 1000, in an embodiment according to the present invention. Elements labeled the same as in FIG. 2, FIG. 3 and FIG. 9A have similar functions. FIG. 10 is described in combination with FIG. 4, FIG. 5, and FIG. 9A.

In the example of FIG. 10, the driving circuit 1000 includes a current filter 920 coupled to a power source 202, a rectifier 204, a power converter 906, a load 208, a saw-tooth signal generator 902, and a controller 910. In one embodiment, the load 208 includes an LED light source such as an LED string. This invention is not so limited; the load 208 can include other types of light sources or other types of loads such as a battery pack. The current filter 920 can be, but is not limited to, an inductor-capacitor (L-C) filter including a pair of inductors and a pair of capacitors. In one embodiment, the controller 910 includes multiple terminals such as a ZCD terminal, a GND terminal, a DRV terminal, a VDD terminal, an FB terminal, a COMP terminal, and a CS terminal.

In one embodiment, the power converter 906 includes an input capacitor 1008 coupled to the power line 912. The input capacitor 1008 reduces ripples of the rectified AC voltage V_{IN} to smooth the waveform of the rectified AC voltage V_{IN}. In one embodiment, the capacitor 1008 has a relatively small capacitance, e.g., less than 0.5 μF, to help eliminate or reduce any distortion of the rectified AC voltage V_{IN}. Moreover, in one embodiment, a current flowing through the capacitor 1008 can be ignored due to the relatively small capacitance. Thus, the current I_{IN} flowing through the switch 316 is approximately equal to the current from the rectifier 204 when the switch 316 is on.

The power converter 906 operates similarly as the power converter 206 in FIG. 3. In one embodiment, the energy storage element 214 includes inductors 302 and 304 magnetically and electrically coupled with each other. The inductor 302 is coupled to the switch 316 and the LED light source 208. Thus, a current I₂₁₄ flows through the inductor 302 according to the conductance status of the switch 316. More specifically, in one embodiment, the controller 910 generates the driving signal 962, e.g., a PWM signal, through the DRV terminal to switch the switch 316 to an ON state or an OFF state. When the switch 316 is turned on, the current I₂₁₄ flows from the power line 912 through the switch 316 and the inductor 302. The current I₂₁₄ increases during the ON state of the switch 316, and can be given according to equation (1):

ΔI₂₁₄=(V_{IN}−V_{OUT})*T_{ON}/L₃₀₂ (1)

where T_{ON} represents a time period when the switch 316 is turned on, ΔI₂₁₄ represents a change of the current I₂₁₄, and L₃₀₂ represents the inductance of the inductor 302. In one embodiment, the controller 920 controls the driving signal 962 to maintain the time period T_{ON} constant. Therefore, the change ΔI₂₁₄ of the current I₂₁₄ during the time period T_{ON} is proportional to the input voltage V_{IN} if V_{OUT} is a substantially constant. In one embodiment, the switch 316 is turned on when the current I₂₁₄ decreases to a predetermined level, e.g., zero ampere. Accordingly, the peak level of the current I₂₁₄ is proportional to the input voltage V_{IN}.

When the switch 316 is turned off, the current I₂₁₄ flows from the ground through the diode 314 and the inductor 302 to the LED light source 208. Accordingly, the current I₂₁₄ decreases according to equation (2):

ΔI₂₁₄=(−V_{OUT})*T_{OFF}/L₃₀₂ (2)

Thus, the current I_{IN} is substantially equal to the current I₂₁₄ during an ON state of the switch 316 and equal to zero ampere during an OFF state of the switch 316, in one embodiment.

The inductor 304 senses an electrical condition of the inductor 302, e.g., whether the current flowing through the inductor 302 decreases to a predetermined level (e.g., zero ampere). As discussed in relation to FIG. 5, the detection signal AUX has a negative level when the switch 316 is turned on, and has a positive level when the switch 316 is turned off, in one embodiment. When the current I₂₁₄ through the inductor 302 decreases to a predetermined current level, a negative-going edge occurs to the voltage of the signal AUX. The ZCD terminal of the controller 910 coupled to the inductor 304 is used to receive the detection signal AUX.

In one embodiment, the power converter 906 includes an output filter 1024. The output filter 1024 can be a capacitor having a relatively large capacitance, e.g., greater than 400 μF. As such, the current I_{OUT} through the LED light source 208 represents an average level of the current I₂₁₄.

The current sensor 218 generates a current sense signal ISEN indicating the current flowing through the inductor 302. In one embodiment, the signal filter 212 is a resistor-capacitor (RC) filter including a resistor 320 and a capacitor 322. The signal filter 212 removes ripples of the current sense signal ISEN to generate an average sense signal IAVG of the current signal ISEN. Thus, in the example of FIG. 10, the average sense signal IAVG indicates the current I_{OUT} flowing through the LED light source 208. The terminal FB of the controller 910 receives the sense signal IAVG, in one embodiment.

The saw-tooth signal generator 902 coupled to the DRV terminal and the CS terminal is operable for generating a saw-tooth signal 960 at the CS terminal according to the driving signal 962 on the DRV terminal. By way of example, the saw-tooth signal generator 902 includes a resistor 1016 and a diode 1018 coupled in parallel between the terminal DRV and the terminal CS, and further includes a resistor 1012 and a capacitor 1014 coupled in parallel between the CS terminal and ground. In operation, the saw-tooth signal 960 varies according to the driving signal 962. More specifically, in one embodiment, the driving signal 962 is a PWM signal. When the driving signal 962 is logic high, a current I1 flows from the DRV terminal through the resistor 1016 to the capacitor 1014. Thus, the capacitor 1014 is charged and a voltage V₉₆₀ of the saw-tooth signal 960 increases. When the driving signal 962 is logic low, a current I2 flows from the capacitor 1014 through the diode 1018 to the DRV terminal. Thus, the capacitor 1014 is discharged and the voltage V₉₆₀ decreases to zero volts. The saw-tooth signal generator 902 can include other components and is not limited to the example shown in FIG. 10.

In one embodiment, the controller 910 is integrated on an integrated circuit (IC) chip. The resistors 1016 and 1012, the diode 1018, and the capacitor 1014 are peripheral components to the IC chip. Alternatively, the saw-tooth signal generator 902 and the controller 910 are both integrated on a single IC chip. In this condition, the terminal CS can be removed, which further reduces the size and the cost of the driving circuit 1000. The power converter 906 can have other configurations and is not limited to the example in FIG. 10.

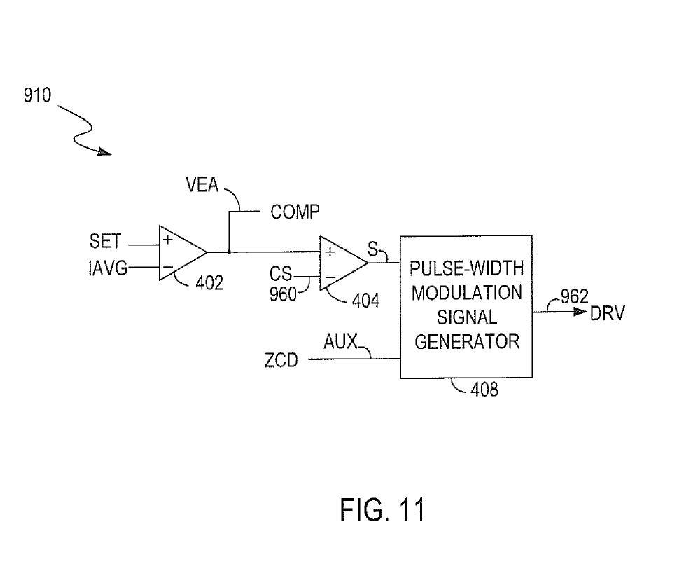

FIG. 11 shows an example of the controller 910 in FIG. 9A, in an embodiment according to the present invention. Elements labeled the same as in FIG. 4 and FIG. 9A have similar functions. FIG. 11 is described in combination with FIG. 4, FIG. 5, FIG. 9A, and FIG. 10.

In one embodiment, the controller 910 has similar configurations as the controller 210 in FIG. 4, except that the CS terminal receives the saw-tooth signal 960 instead of the current sense signal ISEN. The controller 910 generates the driving signal 962 according to the signals including the saw-tooth signal 960, the sense signal IAVG, and the detection signal AUX. The controller 910 includes an error amplifier 402, a comparator 404, and a pulse-width modulation (PWM) signal generator 408. The error amplifier 402 amplifies a difference between the sense signal IAVG and a reference signal SET indicating a target current level to generate the error signal VEA. The comparator 404 compares the saw-tooth signal 960 to the error signal VEA to generate a comparing signal S. The PWM signal generator 408 generates the driving signal 962 according to the comparing signal S and the detection signal AUX.

In one embodiment, the driving signal 962 has a first level, e.g., logic high, to turn on the switch 316 when the detection signal AUX indicates that the current I₂₁₄ through the inductor 302 drops to a predetermined level, e.g., zero ampere. The driving signal 962 has a second level, e.g., logic low, to turn off the switch 316 when the saw-tooth signal 960 reaches the error signal VEA. Advantageously, since the CS terminal receives the saw-tooth signal 960 instead of the sense signal ISEN, a peak level of the current I₂₁₄ through the inductor 302 is not limited by the error signal VEA. Thus, the current I₂₁₄ through the inductor 302 varies according to the input voltage V_{IN} as shown in equation (1). For example, the peak level of the current I₂₁₄ is adjusted to be proportional to the input voltage V_{IN} instead of the error signal VEA.

The controller 910 controls the driving signal 962 to maintain the current I_{OUT} at a target current level represented by the reference signal SET. For example, if the current I_{OUT} is greater than the target level, e.g., due to the variation of the input voltage V_{IN}, the error amplifier 402 decreases the error signal VEA to shorten the time duration T_{ON} of the ON state of the switch 316. Therefore, the average level of the current I₂₁₄ is decreased to decrease the current I_{OUT}. Likewise, if the current I_{OUT} is less than the target level, the controller 910 lengthens the time duration T_{ON} to increase the current I_{OUT}.

FIG. 12 illustrates waveforms of signals generated or received by a driving circuit, e.g., the driving circuit 900 or 1000, in an embodiment according to the present invention. FIG. 12 is described in relation to FIG. 4, FIG. 9A, FIG. 9B, and FIG. 10. FIG. 12 shows the rectified AC voltage V_{IN}, the rectified AC current I_{IN}, the average current I_{IN}_{_{—}}_{AVG} of the current I_{IN}, the current I_{OUT} flowing through the LED light source 208, the sense signal ISEN indicating the current I₂₁₄ flowing through the inductor 302, the error signal VEA, the saw-tooth signal 960, and the driving signal 962.

As shown in the example of FIG. 12, the input voltage V_{IN} is a rectified sinusoidal waveform. At time t1, the driving signal 962 is changed to logic high. Thus, the switch 316 is turned on and the sense signal ISEN indicating the current I₂₁₄ through the inductor 302 increases. Meanwhile, the saw-tooth signal 960 increases according to the driving signal 962.

At time t2, the saw-tooth signal 960 reaches the error signal VEA. Accordingly, the controller 910 adjusts the driving signal 962 to logic low. The saw-tooth signal 960 drops to zero volts. The driving signal 962 turns off the switch 316, thereby decreasing the sense signal ISEN. In other words, the saw-tooth signal 960 and the error signal VEA determine the time period T_{ON} when the driving signal 962 is logic high to turn on the switch 316.

At time t3, the current I₂₁₄ decreases to the predetermined current level, e.g., zero ampere. Thus, the controller 910 adjusts the driving signal 962 to logic high to turn on the switch 316.

In one embodiment, the current I_{OUT} flowing through the LED light source 208 is equal to or proportional to an average level of the current I₂₁₄ over a cycle period of the input voltage V_{IN}. As described in relation to FIG. 11, the current I_{OUT} is adjusted to the target current level represented by the reference signal SET. In addition, as shown in FIG. 12, the sense signal ISEN indicating the current I₂₁₄ between t1 and t4 has same waveforms as those between t5 and t6. Thus, the average level of the current I₂₁₄ between t1 and t4 is equal to the average level of the current I₂₁₄ between t5 and t6. Accordingly, the current I_{OUT} is maintained at the target level. In one embodiment, the time period T_{ON} is determined by the saw-tooth signal 960 and the error signal VEA. In one embodiment, the time period T_{ON} is constant because the time period for the saw-tooth signal 960 to rise from zero volts to the error signal VEA is the same in each cycle of the driving signal 962. Based on equation (1), the change ΔI₂₁₄ of the current I₂₁₄ during the time period T_{ON} is proportional to the input voltage V_{IN}. Therefore, the peak level of the sense signal ISEN is proportional to the input voltage V_{IN} as shown in FIG. 12.

The current I_{IN} has a waveform similar to the waveform of the current I₂₁₄ when the switch 316 is turned on, and is substantially equal to zero ampere when the switch 316 is turned off, in one embodiment. The average current I_{IN}_{_{—}}_{AVG} is substantially in phase with the input voltage V_{IN} between time t1 and t6. As described in relation to FIG. 9B, the AC input current I_{AC} is substantially in phase with the AC input voltage V_{AC}, which corrects the power factor of the driving circuit 900 to improve the power quality.

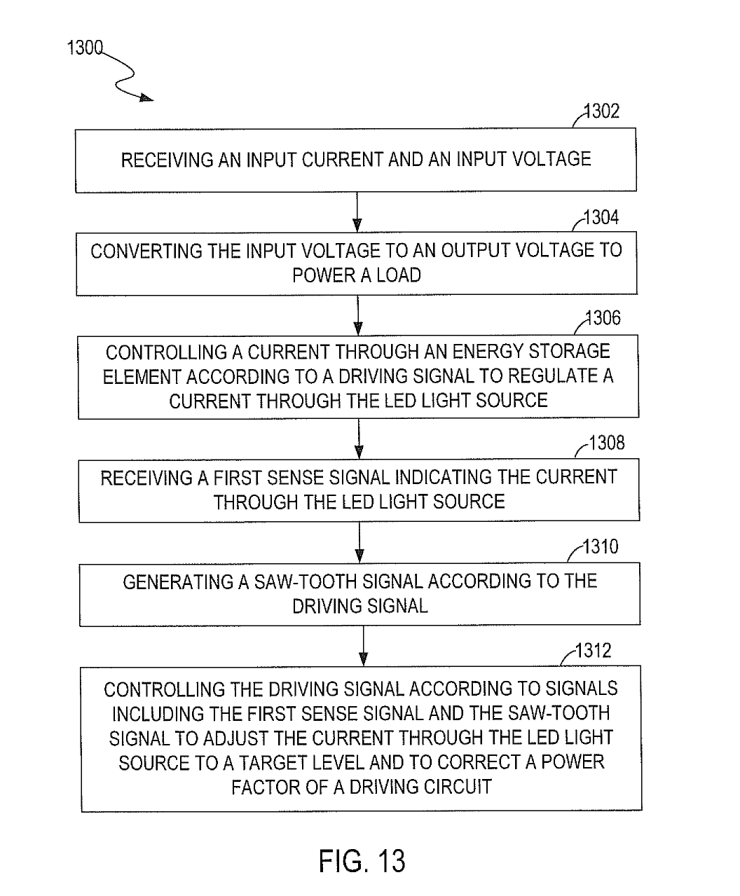

FIG. 13 illustrates a flowchart 1300 of operations performed by a circuit for driving a load, e.g., the circuit 900 or 1000 for driving an LED light source 208, in an embodiment according to the present invention. FIG. 13 is described in combination with FIG. 9A-FIG. 12. Although specific steps are disclosed in FIG. 13, such steps are examples. That is, the present invention is well suited to performing various other steps or variations of the steps recited in FIG. 13.

In block 1302, an input voltage, e.g., the rectified AC voltage V_{IN}, and an input current, e.g., the rectified AC current I_{IN}, are received. In block 1304, the input voltage is converted to an output voltage to power a load, e.g., an LED light source. In block 1306, a current flowing through an energy storage element, e.g., the energy storage element 214, is controlled according to a driving signal, e.g., the driving signal 962, so as to regulate a current through said LED light source.

In block 1308, a first sense signal, e.g., IAVG, indicating the current through said LED light source is received. In one embodiment, the first sense signal is generated by filtering a second sense signal indicating the current through the energy storage element. In block 1310, a saw-tooth signal is generated based on the driving signal.

In block 1312, the driving signal is controlled based on signals including the saw-tooth signal and the first sense signal to adjust the current through the LED light source to a target level and to correct a power factor of the driving circuit by controlling an average current of the input current to be substantially in phase with the input voltage. In one embodiment, an error signal indicating a difference between the first sense signal and a reference signal indicating the target level of the current through the LED light source is generated. The saw-tooth signal is compared to the error signal. A detection signal indicating an electric condition of the energy storage element is received. The driving signal is switched to a first state if the detection signal indicates that the current through the energy storage element decreases to a predetermined level and is switched to a second state according to a result of the comparison of the saw-tooth signal and the error signal. The current through the energy storage element is increased when the driving signal is in the first state and is decreased when the driving signal is in the second state. In one embodiment, a time duration for the saw-tooth signal to increase from a predetermined level to the error signal is constant if the current through the LED light source is maintained at the target level.

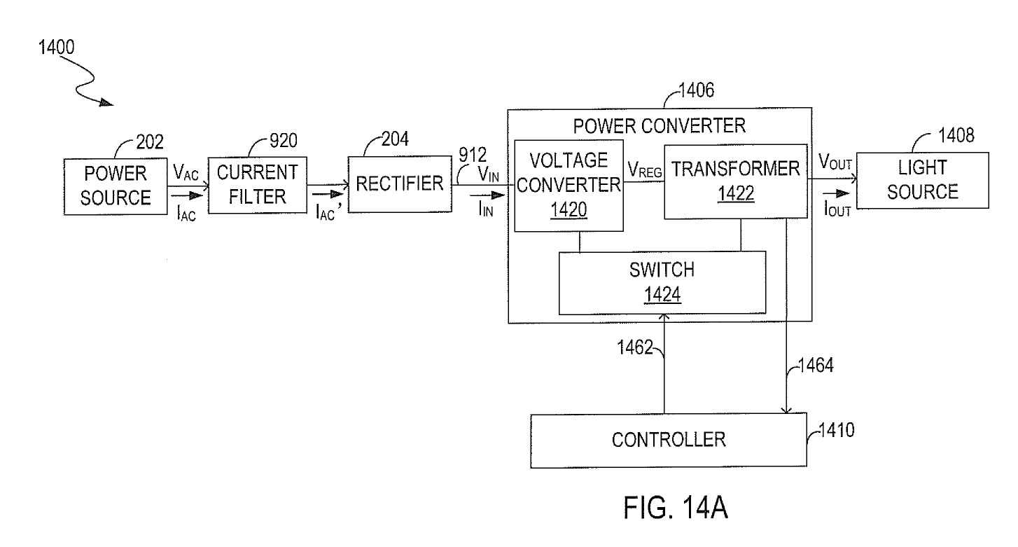

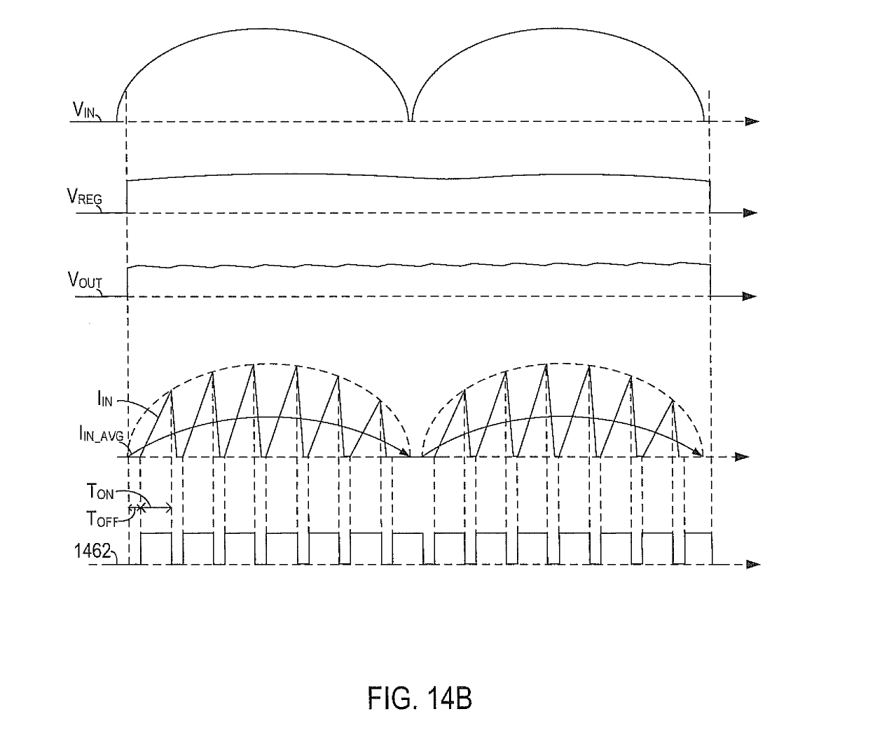

FIG. 14A shows another block diagram of a driving circuit 1400, in an embodiment according to the present invention. Elements labeled the same as in FIG. 2, FIG. 3, and FIG. 9A have similar functions. FIG. 14B illustrates waveforms of signals generated or received by the driving circuit 1400 in an embodiment according to the present invention. FIG. 14A and FIG. 14B are described in combination with FIG. 9A and FIG. 9B.

In the example of FIG. 14A, the driving circuit 1400 includes a current filter 920 coupled to a power source 202, a rectifier 204, a power converter 1406, a light source 1408, and a controller 1410. The power source 202 generates an AC input voltage V_{AC} having, e.g., a sinusoidal waveform, and an AC input current I_{AC}. The AC input current I_{AC} flows into the current filter 920, and a current I_{AC}′ flows from the current filter 920 to the rectifier 204. The rectifier 204 receives the AC input voltage V_{AC} via the current filter 920 and provides a rectified AC voltage V_{IN} and a rectified AC current I_{IN} at the power line 912 coupled between the rectifier 204 and the power converter 1406.

In one embodiment, the power converter 1406 includes a voltage converter 1420, a transformer 1422, and a switch 1424. The voltage converter 1420 receives the voltage V_{IN}, and filters the voltage V_{IN} to generate a regulated voltage V_{REG}. For example, relatively high frequency harmonic components of the voltage V_{IN} are excluded or removed. Thus, as shown in FIG. 14B, the waveform of the regulated voltage V_{REG} is more stable than the waveform of the voltage V_{IN}. The transformer 1422 converts the regulated voltage V_{REG} to an output voltage V_{OUT} to power the light source 1408. Thus, the waveform of the output voltage V_{OUT} is not affected by the variations of the input voltage V_{IN}, e.g., a sinusoidal waveform. Accordingly, ripples of the current I_{OUT} flowing through the light source 1408 caused by variations of the input voltage V_{IN} are reduced or eliminated, which further reduces the line frequency interferences for the light emitted by the light source 1408.

The controller 1410 generates a driving signal 1462 to operate the switch 1424 in a first state or a second state, which further controls an input current I_{IN} flowing into the voltage converter 1420 and controls an output current I_{OUT} flowing through the light source 1408. In one embodiment, the transformer 1422 provides a sense signal 1464 indicating the output current I_{OUT}. Based on the sense signal 1464, the controller 1410 controls a ratio of the time period T_{ON} to the time period T_{OFF} of the switch 1424 to adjust the current I_{OUT} to a target level.

In one embodiment, the input current I_{IN} increases during operation in the first state of the switch 1424 and decreases during operation in the second state of the switch 1424. The controller 1410 controls a time duration of the second state to allow the input current I_{IN} to decrease to a predetermined level, e.g., ground, during operation in the second state. The controller 1410 further controls a time duration of the first state to allow the input current to increase from said predetermined level to a level proportional to the input voltage V_{IN}. An average current I_{IN}_{_{—}}_{AVG} of the current I_{IN} is substantially in phase with the input voltage V_{IN} accordingly. Similar to the discussion in relation to FIG. 9B, the current I_{AC} is substantially in phase with the input voltage V_{AC}. Ideally, the AC input voltage V_{AC} and the AC input current I_{AC} are in phase. However, in practical application, there might be a slight phase difference due to capacitors in the current filter 920 and the power converter 1406. Moreover, the shape of the waveform of the input AC current I_{AC} is similar to the shape of the waveform of the input AC voltage V_{AC}. Therefore, the power factor of the circuit 1400 is corrected.

Advantageously, by switching the single switch 1424 between the first state and the second state, the power factor of the circuit 1400 is corrected and the output current I_{OUT} is adjusted to the target level. Thus, both the power quality of the circuit 1400 and the accuracy of the current control are improved. As only the single switch 1424 is employed for the control, the size and the cost of the circuit 1400 are reduced.

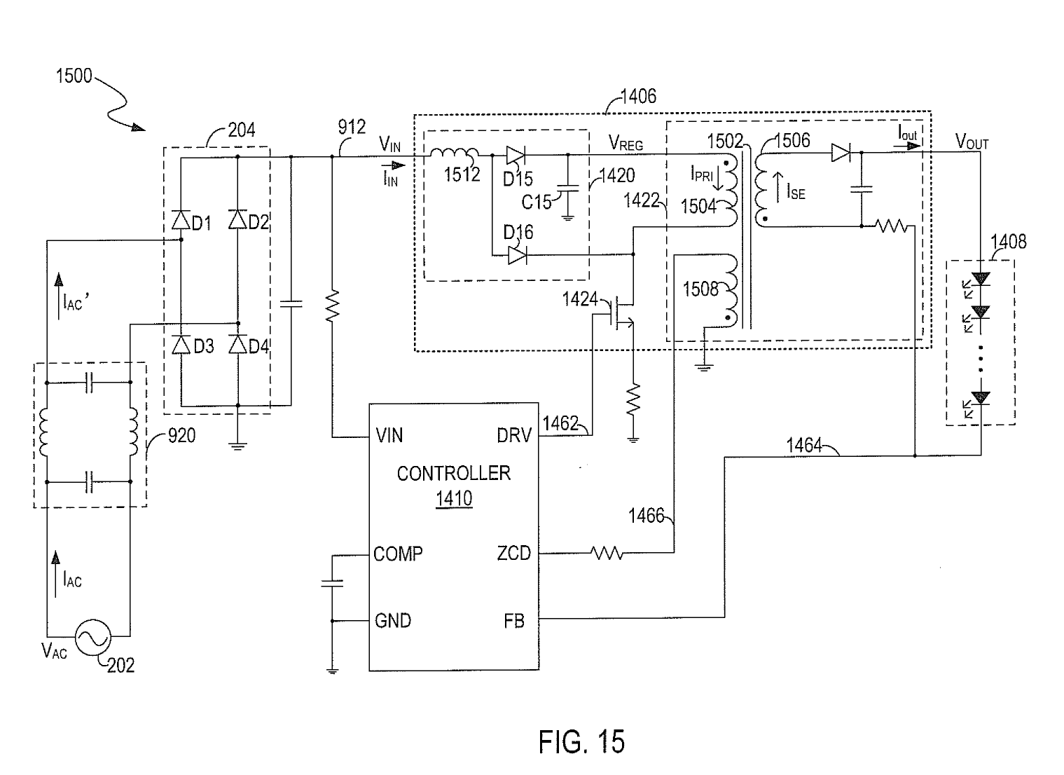

FIG. 15 shows an example schematic diagram of a driving circuit 1500, in an embodiment according to the present invention. Elements labeled the same as in FIG. 2, FIG. 3, FIG. 9A, and FIG. 14A have similar functions. FIG. 15 is described in combination with FIG. 14A and FIG. 14B. In one embodiment, the controller 1410 includes multiple pins such as a VIN pin, a COMP pin, a GND pin, a DRV pin, a CS pin, a VDD pin, a ZCD pin, and an FB pin.

In one embodiment, the voltage regulator 1420 includes an inductor 1512, diodes D15 and D16, and a capacitor C15. The transformer 1422 can be a flyback converter including a primary winding 1504, a secondary winding 1506, an auxiliary winding 1508, and a core 1502. The switch 1424 is coupled to the diode D16 and the primary winding 1504, and operates in the first state, e.g., an ON state, and the second state, e.g., an OFF state, to control the current I_{IN} flowing through the inductor 1512 and to control the current I_{OUT} flowing through the LED light source 1408.

In one embodiment, the controller 1410 generates the driving signal 1462, e.g., a pulse-width modulation signal, to control the switch 1424. More specifically, in one embodiment, when the driving signal 1462 has a high electrical level, e.g., during an ON time period T_{ON}, the switch 1424 is turned on, the diode D15 is reverse biased, and the diode D16 is forward biased. The transformer 1422 is powered by the regulated voltage V_{REG}. The current I_{PRI} flows through the primary winding 1504, the switch 1424, and ground. The current I_{PRI} increases to store energy to the core 1502. Moreover, the current I_{IN} flows through the inductor 1512, the diode D16, and the switch 1424, and increases to charge the inductor 1512, and can be given as equation (3):

ΔI_{IN}=V_{IN}*T_{CH}/L₁₅₁₂ (3)

where T_{CH} represents a charging time period when the inductor 1512 is charged during the ON state of the switch 1424, ΔI_{IN} represents a change of the current I_{IN}, and L₁₅₁₂ represents the inductance of the inductor 1512. In one embodiment, the time period T_{CH} is equal to the time period T_{ON} when the switch 1424 is turned on.

When the driving signal 1462 has a low electrical level, e.g., during an OFF time period T_{OFF}, the switch 1424 is turned off, the diode D15 is forward biased, and the diode D16 is reverse biased. The transformer 1422 is discharged to power the LED light source 1408. Therefore, the current I_{SE} flowing through the secondary winding 1506 decreases. Moreover, the current I_{IN} flows through the inductor 1512, the diode D15, and the capacitor C15, and decreases according to equation (4) to discharge the inductor 1512:

ΔI_{N}=(V_{IN}−V_{REG})*T_{DISCH}/L₁₅₁₂ (4)

where T_{DISCH} represents a time period when the inductor 1512 is discharged during the OFF state of the switch 1424. Since the discharging of the inductor 1512 is terminated once the current I_{IN} decreases to zero ampere, the time period T_{DISCH} can be different from the time period T_{OFF} for the OFF state.

In one embodiment, the inductor 1512 and the capacitor C15 constitute an inductor-capacitor (LC) filter. The LC filter filters out the higher frequency harmonic components of the voltage V_{IN}. As such, ripples of the waveform of the regulated voltage V_{REG} caused by the variations of the voltage V_{IN} are reduced. The transformer 1422 converts the regulated voltage V_{REG} to the output voltage V_{OUT}, which is also independent of the voltage V_{IN}.

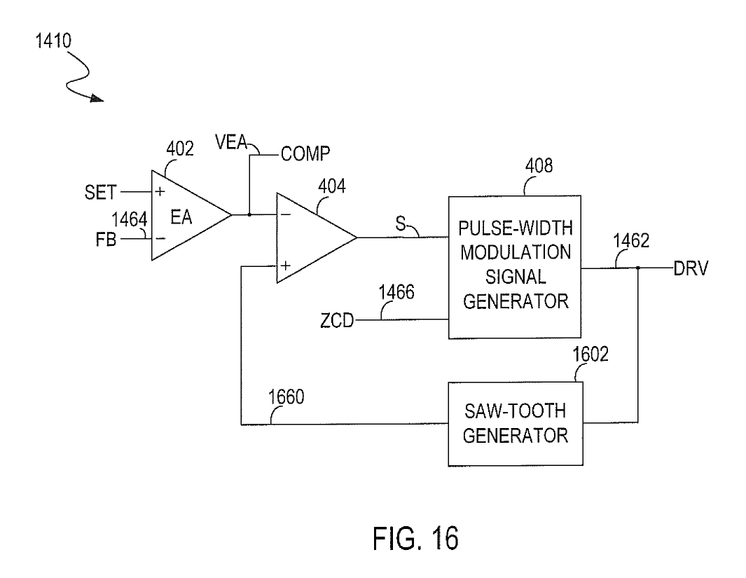

In one embodiment, the auxiliary winding 1508 is coupled to the controller 1410 via the ZCD pin. The auxiliary winding 1508 provides a current detection signal 1466 indicating whether the current I_{SE} drops to the predetermined level, e.g., zero ampere. The FB pin of the controller 1410 receives a sense signal 1464 indicating the current I_{OUT} flowing through the LED light source 1408. In one embodiment, the controller 1410 controls a duty cycle of the driving signal 1462 based on signals including the current detection signal 1466 and the sense signal 1464 to adjust the current I_{OUT} to the target current level. The operation of the controller 1410 is further described in relation to FIG. 16.

In one embodiment, the controller 1410 further controls the time periods T_{ON} and T_{OFF} of the driving signal 1462 to correct a power factor of the circuit 1500. More specifically, in one embodiment, the controller 1410 sets the time period T_{OFF} of the OFF state to be greater than a time threshold T_{TH}. By rewriting the equation (4), the discharging time of the inductor 1512 can be given by:

T_{DISCH}=ΔI_{IN}*L₁₅₁₂/(V_{IN}−V_{REG}) (5)

As shown in FIG. 14B, ΔI_{IN} can be different in different cycle periods of the driving signal 1462. In one embodiment, the time threshold T_{TH} can be set to an amount equal to or greater than a maximum discharging time T_{DISCH}_{_{—}}_{MAX} of the inductor 1512. As such, the duration of the OFF state of the switch 1424 is sufficient to allow the current I_{IN} to decrease to zero ampere. Moreover, the controller 1410 maintains the time duration T_{ON} at a constant value. Thus, according to equation (3), the current I_{IN} increases from the predetermined level to the peak level proportional to the input voltage V_{IN}. Therefore, as described in relation to FIG. 14A and FIG. 14B, the power factor of the circuit 1500 is corrected to improve the power quality of the circuit 1500.

FIG. 16 shows an example of the controller 1410 in FIG. 14A, in an embodiment according to the present invention. Elements labeled the same as in FIG. 4 and FIG. 9A have similar functions. FIG. 16 is described in combination with FIG. 4, FIG. 5, FIG. 10, and FIG. 11.

In one embodiment, the controller 1410 has a similar configuration as the controller 910 in FIG. 11, except that the controller 1410 further includes a saw-tooth signal generator 1602 that generates a saw-tooth signal 1660. In one embodiment, the saw-tooth generator 1402 operates similarly as the saw-tooth generator 902 shown in FIG. 10. The saw-tooth signal 1660 ramps up when the driving signal 1462 turns on the switch 1424 and drops to zero ampere when the driving signal 1462 turns off the switch 1424.

The controller 1410 generates the driving signal 1462 according to the signals including the saw-tooth signal 1660, the sense signal 1464, and the detection signal 1466. The controller 1410 further includes an error amplifier 402, a comparator 404, and a pulse-width modulation (PWM) signal generator 408. The error amplifier 402 amplifies a difference between the sense signal 1464 and a reference signal SET indicating a target current level to generate the error signal VEA. The comparator 404 compares the saw-tooth signal 1660 to the error signal VEA to generate a comparing signal S. The PWM signal generator 408 generates the driving signal 1462 according to the comparing signal S and the detection signal AUX. T_{ON} corresponds to the amount of time it takes for a saw-tooth signal 1660 to increase from a predetermined level to the error signal VEA.

In one embodiment, the driving signal 1462 can have a high electrical level to turn on the switch 1424 when the detection signal 1466 indicates that the current I_{SE} through the secondary winding 1506 drops to a predetermined level, e.g., zero ampere. The driving signal 1462 can also have a low electrical level to turn off the switch 1424 when the saw-tooth signal 1660 reaches the error signal VEA.

The controller 1410 controls the driving signal 1462 to maintain the current I_{OUT} at a target current level represented by the reference signal SET. For example, if the current I_{OUT} is greater than the target level, e.g., due to undesirable noise, the error amplifier 402 decreases the error signal VEA to shorten the time period T_{ON} of the ON state of the switch 1424. Therefore, the duty cycle of the driving signal 1462 is decreased to decrease the current I_{OUT}. Likewise, if the current I_{OUT} is less than the target level, the controller 1410 increases the duty cycle of the driving signal 1462 to increase the current I_{OUT}. In one embodiment, if the current I_{OUT} is maintained at the target level, then the time period T_{ON} is maintained at a constant value.

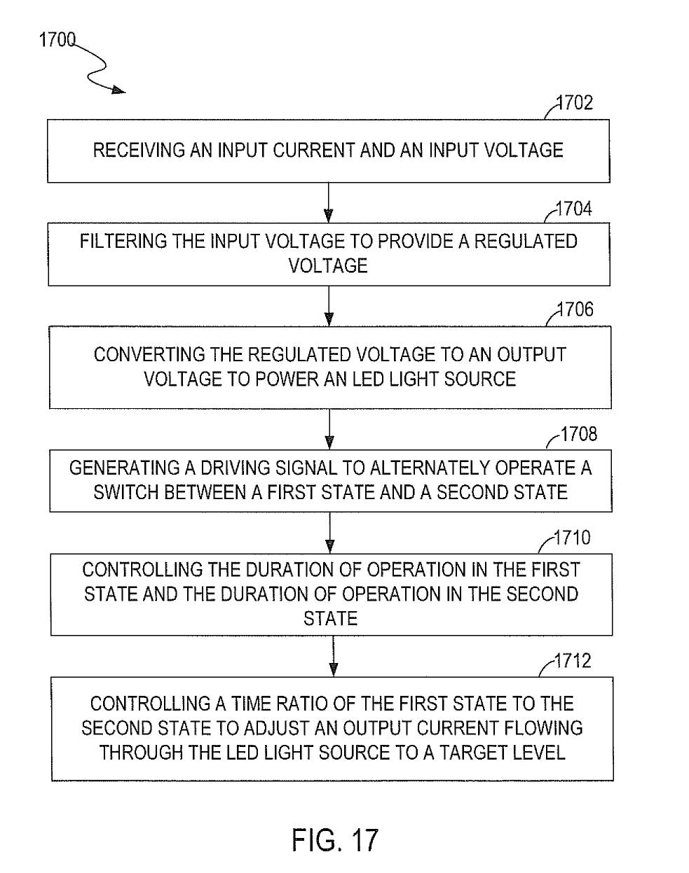

FIG. 17 illustrates a flowchart 1700 of examples of operations performed by a circuit for driving a light source 1408, in an embodiment according to the present invention. FIG. 17 is described in combination with FIG. 14A-FIG. 16. Although specific steps are disclosed in FIG. 17, such steps are examples. That is, the present invention is well suited to performing various other steps or variations of the steps recited in FIG. 17.

In block 1702, an input current, e.g., the input current I_{IN}, and an input voltage, e.g., the input voltage V_{IN}, are received. In block 1704, the input voltage is filtered to provide a regulated voltage, e.g., the regulated voltage V_{REG}. In block 1706, the regulated voltage is converted to an output voltage, e.g., the output voltage V_{OUT}, to power the LED light source. In block 1708, a driving signal, e.g., the driving signal 1462, is generated to alternately operate a switch, e.g., the switch 1424, between a first state and a second state. The input current is increased during the first state and is decreased during the second state.

In block 1710, the duration of operation in the first state and the duration of operation in the second state are controlled, such that the input current decreases to a predetermined level, e.g., zero ampere, during operation in the second state and increases from the predetermined level to a peak level proportional to the input voltage during operation in the first state.

In block 1712, a time ratio—the ratio of the amount of time in the first state to the amount of time in the second state—is controlled to adjust the output current flowing through the LED light source to a target level.

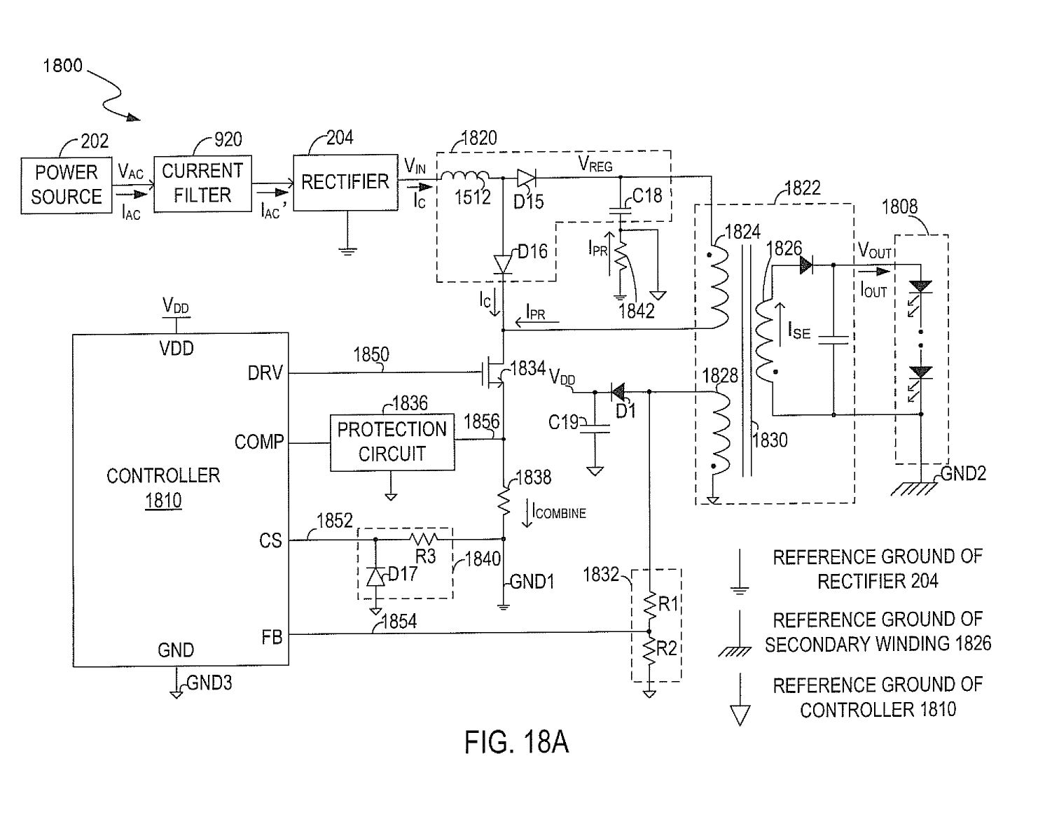

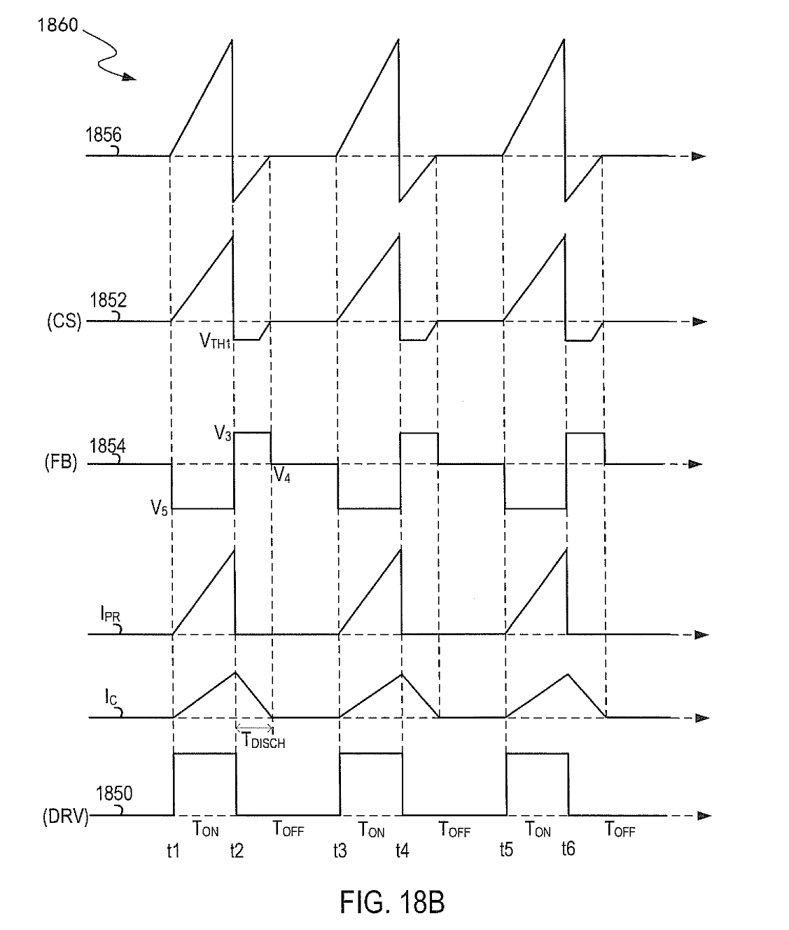

FIG. 18A illustrates another example of a diagram of a driving circuit 1800, in an embodiment according to the present invention. Elements labeled the same as in FIG. 2 and FIG. 9A have similar functions. FIG. 18A is described in combination with FIG. 14A.

In the example of FIG. 18A, the driving circuit 1800 includes a power source 202, a current filter 920, a rectifier 204, a converter 1820, a transformer 1822, a sensor 1838, a sensor 1842, a switch 1834, a protection circuit 1836, an LED light source 1808, and a controller 1810. The power source 202 generates an AC input voltage V_{AC}, e.g., having a sinusoidal waveform, and an AC input current I_{AC}. The AC input current I_{AC} flows into the current filter 920, and a current I_{AC}′ flows from the current filter 920 to the rectifier 204. The rectifier 204 receives the AC input voltage V_{AC} via the current filter 920 and provides a rectified AC voltage V_{IN} and a rectified AC current I_{C} to the converter 1820. The converter 1820 provides a regulated voltage V_{REG} to the transformer 1822. The transformer 1822 transforms the voltage V_{REG} to an output voltage V_{OUT} to power the light source 1808. The controller 1810 controls an output current I_{OUT} to maintain the brightness of the LED light source 1808 at a target level, and controls the current I_{C} to correct the power factor of the driving circuit 1800. In one embodiment, the controller 1810 includes multiple pins such as a DRV pin, a COMP pin, a CS pin, an FB pin, a GND pin, and a VDD pin.

In one embodiment, the converter 1820 coupled to the switch 1834 includes an inductor 1512, a diode D15, a diode D16, and a capacitor C18. The transformer 1822 coupled to the switch 1834 can be a flyback converter including a primary winding 1824, a secondary winding 1826, an auxiliary winding 1828, and a core 1830. The rectifier 204 has a reference ground GND1. The secondary winding 1826 has a reference ground GND2. Circuitry in the secondary side of the driving circuit 1800 shares the reference ground GND2 with the secondary winding 1826. The controller 1810 has a reference ground GND3. Circuitry including the converter 1820, the primary winding 1824, the auxiliary winding 1828, the protection circuit 1836, and the clamp circuit 1840 shares the reference ground GND3 with the controller 1810. In one embodiment, the reference grounds GND1, GND2, and GND3 have different reference voltages.

In one embodiment, the controller 1810 generates a driving signal 1850 at the DRV pin to operate the switch 1834 in a first state, e.g., an ON state, or a second state, e.g., an OFF state. Thus, the switch 1834 controls a current I_{C} flowing through the converter 1820 and a current I_{PR} flowing through the primary winding 1824, so as to control the output current I_{OUT} flowing through the LED light source 1808.

FIG. 18B illustrates a waveform 1860 of signals generated or received by the driving circuit 1800, in an embodiment according to the present invention. FIG. 18B is described in combination with FIG. 18A. FIG. 18B shows the driving signal 1850, the current I_{C} through the converter 1820, the current I_{PR} through the primary winding 1824, a sense signal 1852, a detection signal 1854, and a sense signal 1856.

In the example of FIG. 18B, the driving signal 1850 is a pulse-width-modulation (PWM) signal. The driving signal 1850 has a first level, e.g., a high electrical level, during a time period T_{ON}, e.g., a time period from t1 to t2, from t3 to t4, or from t5 to t6. The driving signal 1850 has a second level, e.g., a low electrical level, during a time period T_{OFF}, e.g., a time period from t2 to t3, or from t4 to t5.

When the driving signal 1850 has a high electrical level, e.g., during the time period T_{ON}, the switch 1834 is turned on. As such, the diode D15 is reverse biased and the diode D16 is forward biased. The transformer 1822 is powered by the regulated voltage V_{REG}. The current I_{PR} flows through the capacitor C18, the primary winding 1824, and the switch 1834. As shown in FIG. 18B, the current I_{PR} increases to transfer energy from the converter 1820 to the core 1830, and can be given as equation (6):

ΔI_{PR}=V_{REG}*T_{ON}/L₁₈₂₄ (6)

where ΔI_{PR} represents a change of the current I_{PR}, and L₁₈₂₄ represents the inductance of the primary winding 1824. The current I_{PR} reaches a peak level I_{PK} at the time of an operation to turn off the switch 1834. Moreover, the current I_{C} flows through the inductor 1512, the diode D16, and the switch 1834, and increases to charge the inductor 1512, and can be given as equation (7):

ΔI_{C}=V_{IN}*T_{ON}/L₁₅₁₂ (7)

where ΔI_{C} represents a change of the current I_{C}, and L₁₅₁₂ represents the inductance of the inductor 1512. Therefore, both the current I_{C} and the current I_{PR} flow through the switch 1834 when the switch 1834 is turned on.

When the driving signal 1850 has a low electrical level, e.g., during the time period T_{OFF}, the switch 1834 is turned off. As such, the diode D15 is forward biased, and the diode D16 is reverse biased. The current I_{SE} through the secondary winding 1826 decreases to transfer energy from the core 1830 to the LED light source 1808, and can be given as equation (8):

ΔI_{SE}=(−V_{OUT})*T_{DIS}/L₁₈₂₆ (8)

where T_{DIS} represents a time period when the current I_{SE} decreases, and L₁₈₂₆ represents the inductance of the secondary winding 1826. Moreover, the current I_{C} flows from the rectifier 204, through the inductor 1512, the diode D15, and the capacitor C18, and to the reference ground GND3. As shown in FIG. 18B, the current I_{C} decreases to discharge the inductor 1512 according to equation (9):

ΔI_{C}=(V_{IN}−V_{REG})*T_{DISCH}/L₁₅₁₂ (9)

where T_{DISCH} represents a time period when the inductor 1512 is discharged during the OFF state of the switch 1834. Since the discharging of the inductor 1512 is terminated once the current I_{C} decreases to zero ampere, the time period T_{DISCH} can be different from the time period T_{OFF} for the OFF state. As shown in the example of FIG. 18B, the time period T_{DISCH} is less than the time period T_{OFF}.

In one embodiment, the auxiliary winding 1828 provides a detection signal 1854 indicating whether the transformer 1822 operates in a predetermined state. In one embodiment, the FB pin of the controller 1810 is coupled to the auxiliary winding 1828 via a voltage divider 1832 for receiving the detection signal 1854. For example, the voltage divider 1832 can be resistors R1 and R2 coupled in series. More specifically, in one embodiment, when the switch 1834 is turned off and the current I_{SE} decreases, e.g., during T_{DIS}, a voltage across the auxiliary winding 1828 is positive. Thus, as shown in FIG. 18B, the detection signal 1854 has a positive voltage level V₃. When the detection signal 1854 has the voltage level V₃, it indicates that the transformer 1822 is operating in the predetermined state. When the current I_{SE} drops to zero ampere, the voltage across the auxiliary winding 1828 is zero volts and the detection signal 1854 has a voltage level V₄, e.g., zero volts. When the switch 1834 is turned on and the current I_{PR} increases, the voltage across the auxiliary winding 1828 is negative and the detection signal 1854 has a negative voltage level V₅. When the detection signal 1854 has the voltage level V₄ or V₅, it indicates that the transformer 1822 operates in a state other than the predetermined state.

In one embodiment, the sensors 1838 and 1842 can be a pair of resistors coupled together. Advantageously, due to innovative electronic connections among the switch 1834, the reference ground GND1, the reference ground GND3, and the sensors 1838 and 1842 as shown in the FIG. 18A, a sense signal 1852 indicating only the current I_{PR} is provided even if the current I_{C} and the current I_{PR} both flow through the switch 1834 during the time period T_{ON}. The sense signal 1852 can be used by the controller 1810 to obtain information about the output current I_{OUT} through the LED light source 1808. Thus, a sensor (coupled to circuitry in the secondary side of the circuit 1800) and an isolator (coupled between circuitry in the secondary side and that in the primary side of the circuit 1800) are both removed.

More specifically, in one embodiment, the resistor 1838 is coupled between the switch 1834 and the reference ground GND1. The resistor 1842 is coupled between the reference ground GND1 and the reference ground GND3. In one embodiment, as the resistor 1838 is coupled in series with the switch 1834, both the current I_{C} and the current I_{PR} further flow through the resistor 1838 during the time period T_{ON}. As such, the resistor 1838 senses a combined current I_{COMBINE} of the current I_{C} and the current I_{PR}. In one embodiment, the reference ground GND1 is further coupled to a current path for the current I_{C}. For example, the current I_{C} can be conducted to flow through the rectifier 204 and the inductor 1512. Thus, the current I_{C} flows through the current path for the current I_{C} other than the resistor 1842. The current I_{PR}, however, flows through the resistor 1842, because the reference ground GND3 is coupled to the capacitor C18. Therefore, when the switch 1834 is turned on, the current I_{C} flows from the rectifier 204, through the inductor 1512, the diode D16, the switch 1834, the resistor 1838, and the reference ground GND1, and back to the rectifier 204. The current I_{PR} flows from the capacitor C18, through the primary winding 1824, the switch 1834, the resistor 1838, the reference ground GND1, and the resistor 1842, and back to the capacitor C18. As a result, the resistor 1838 senses the combined current I_{COMBINE}, e.g., having a current level equal to a sum of the current I_{C} and the current I_{PR}. Moreover, the resistor 1842 senses only the current I_{PR}.

In one embodiment, the CS pin of the controller 1810 is coupled to the reference ground GND1. Since the controller 1810 has the reference ground GND3, the controller 1810 can receive the sense signal 1852 indicating the current I_{PR}. For example, the sense signal 1852 can be represented by a voltage across the resistor 1842. In one embodiment, the protection circuit 1836 is coupled to a common node of the switch 1834 and the resistor 1838, and receives a sense signal 1856 indicating the combined current I_{COMBINE}. In one embodiment, the sense signal 1856 can be represented by a total voltage V_{TO} across the resistor 1838 and the resistor 1842, and can be given according to:

V_{TO}=I_{C}*R₁₈₃₈+I_{PR}*(R₁₈₃₈+R₁₈₄₂) (10)

where R₁₈₃₈ represents the resistance of the resistor 1838, and R₁₈₄₂ represents the resistance of the resistor 1842. In an alternative embodiment, the protection circuit 1836 includes a pair of terminals coupled to the terminals of the resistor 1838. Thus, the terminals of the protection circuit 1836 receive a sense signal represented by only the voltage across resistor 1838, e.g., I_{COMBINE}*R₁₈₃₈.

As shown in FIG. 18B, during the time period T_{ON}, both the current I_{C} and the current I_{PR} increase. Accordingly, the sense signal 1852 indicating the current I_{PR} increases, and the sense signal 1856 indicating the combined current I_{COMBINE} of the current I_{C} and the current I_{PR} increases. During the time period T_{OFF}, the current I_{C} flows from the capacitor C18, through the resistor 1842, and to the reference ground GND1. Since the sense signal 1852 has a voltage equal to the voltage across the resistor 1842, the sense signal 1852 is negative and inversely proportional to the current I_{C}.

In one embodiment, the driving circuit 1800 further includes a clamp circuit 1840. The clamp circuit 1840 clamps the voltage V₁₈₅₂ of the sense signal 1852 to a predetermined level to prevent the voltage V₁₈₅₂ from dropping below a predetermined threshold V_{TH1}. In one embodiment, the clamp circuit 1840 includes a diode D17 and a resistor R3. The predetermined threshold V_{TH1} can be a threshold associated with the diode D17, e.g., negative 0.7 volts. If the voltage V₁₈₅₂ is greater than V_{TH1}, the diode D17 is reverse biased. Then, the voltage V₁₈₅₂ is determined by the voltage across the resistor 1842. If the voltage V₁₈₅₂ is less than V_{TH1}, the diode D17 is forward biased and a current flows through the diode D17 and R3. As a voltage is generated across the diode D17, the voltage V₁₈₅₂ is clamped to the predetermined level, e.g., negative 0.7 volts. Therefore, as shown in FIG. 18B, the sense signal 1852 is clamped to a level equal to V_{TH1} if the voltage across the resistor 1842 is less than the voltage V_{TH1}, and increases inversely proportional to the current I_{C} if the voltage across the resistor 1842 is greater than the voltage V_{TH1}, in one embodiment. Furthermore, no current flows through the resistor 1838. As such, the voltage of the sense signal 1856 is equal to the voltage across the resistor 1842 when the switch 1834 is turned off.

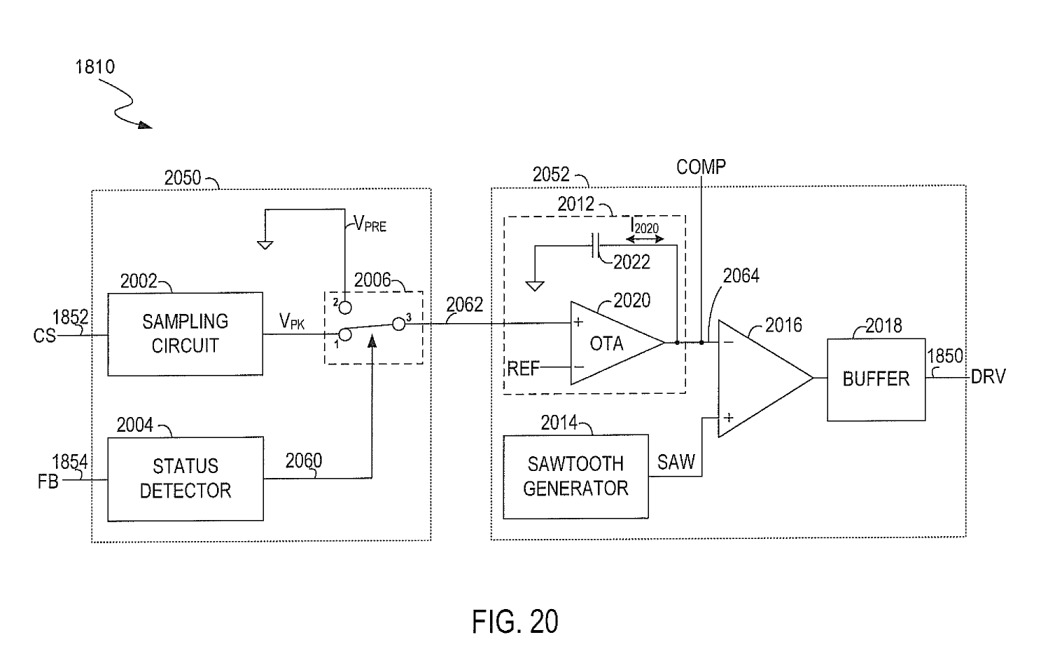

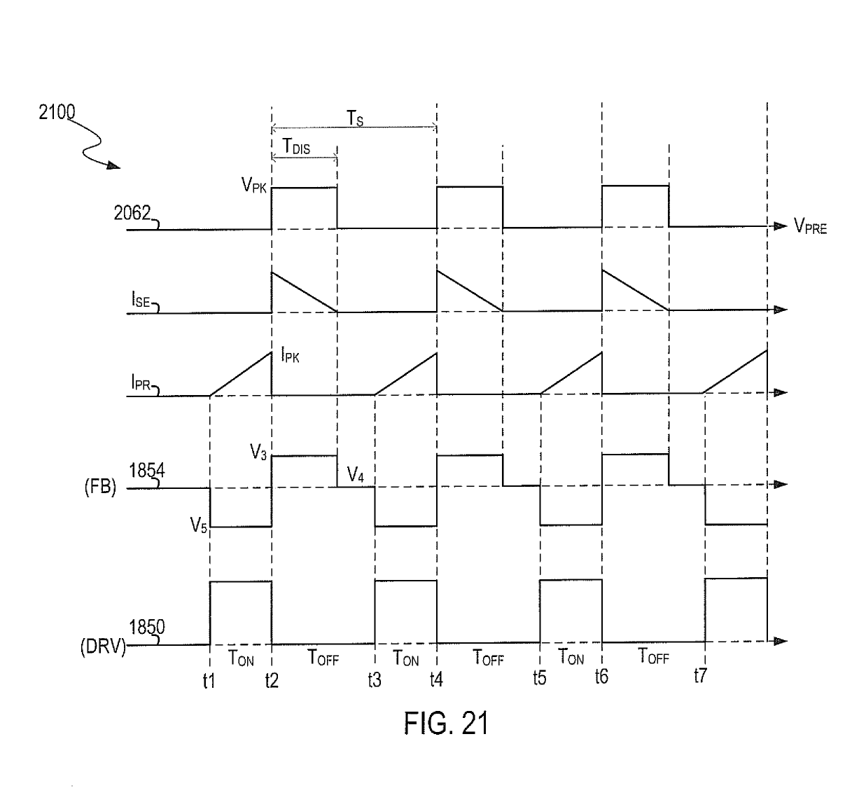

The controller 1810 receives the detection signal 1854 via the FB pin and receives the sense signal 1852 indicating the current I_{PR} through the primary winding 1824. In one embodiment, the controller 1810 monitors the output current I_{OUT} through the LED light source 1808 based on the sense signal 1852 and the detection signal 1854. As is further described in relation to FIG. 20 and FIG. 21, based on the signals 1852 and 1854, the controller 1810 can generate a square wave signal having an average voltage proportional to the output current I_{OUT}. Accordingly, the controller 1810 generates the driving signal 1850 to control the switch 1834, which adjusts the current I_{OUT} to a target current level I_{TARGET}.

Advantageously, the controller 1810 can sense the output current I_{OUT} according to the sense signal 1852 and the detection signal 1854 which are both generated by circuitry on the primary side of the driving circuit 1800. Therefore, a current sense circuit on the secondary side and an isolation circuit coupled between the primary side and the secondary side of the driving circuit 1800 are both omitted. Thus, the size and the cost of the driving circuit 1800 are reduced.

In one embodiment, the protection circuit 1836 is further coupled to the COMP pin of the controller 1810. The protection circuit 1836 compares the sense signal 1856 to a threshold V_{TH2}, and pulls a voltage of the COMP pin to a predetermined level, e.g., equal to a voltage at the reference ground GND3, according to a result of the comparison. More specifically, in one embodiment, the protection circuit 1836 can be but is not limited to a transistor (not shown) having a gate for receiving the sense signal 1856, a drain coupled to the COMP pin, and a source coupled to the reference ground GND3. If a voltage of the sense signal 1856 is greater than the threshold V_{TH2}, e.g., a threshold associated with the transistor, the transistor conducts the COMP pin to the reference ground GND3. In response, the controller 1810 controls the driving signal 1850 to protect the driving circuit 1800 from an over-current condition. In one embodiment, the controller 1810 maintains the switch 1834 off if the voltage of the COMP pin is pulled down to a voltage level equal to that at the reference ground GND3, which is further described in relation to FIG. 20. Then, both the current I_{C} and the current I_{PR} are cut off. Advantageously, the sense signal 1856 indicates the combined current I_{COMBINE} rather than a single current I_{C} or I_{PR}. Thus, an over-current condition of either the current I_{C} or the current I_{PR} may trigger the protection circuit 1836 to pull down the voltage at the COMP pin, which protects the circuit 1800 from being damaged.

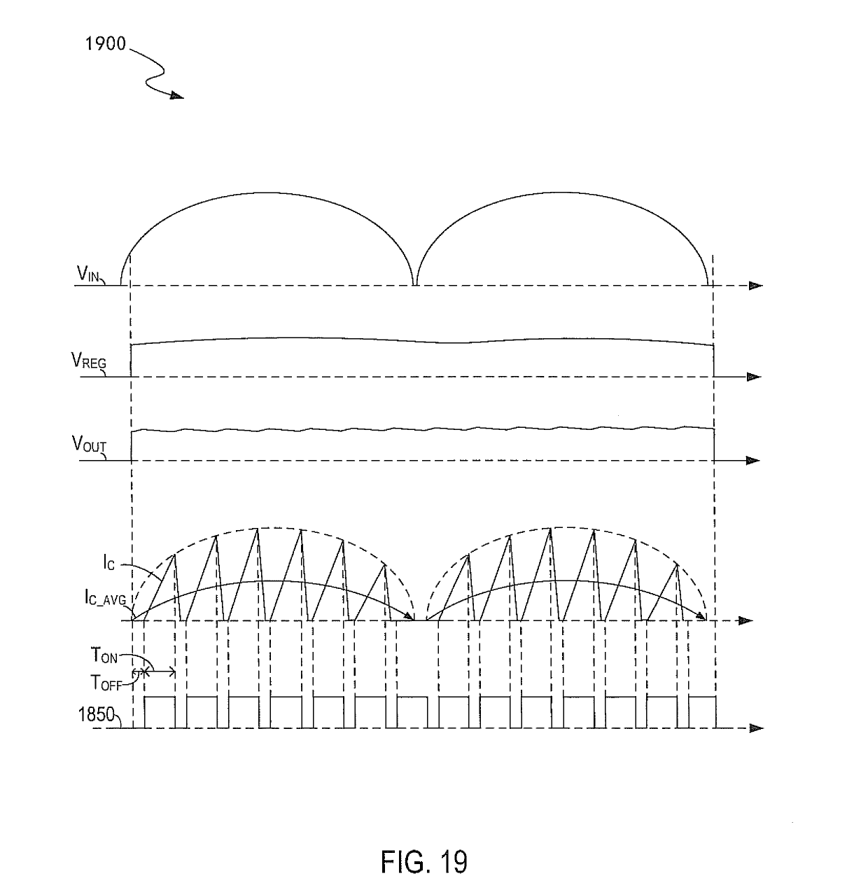

FIG. 19 illustrates waveforms 1900 of signals generated or received by the driving circuit 1800, in an embodiment according to the present invention. FIG. 19 is described in combination with FIG. 14B, FIG. 18A, and FIG. 18B. FIG. 19 shows the input voltage V_{IN}, the regulated voltage V_{REG}, the output voltage V_{OUT}, the current I_{C}, an average level I_{C}_{_{—}}_{AVG} of the current I_{C}, and the driving signal 1850.

As described in relation to FIG. 18A and FIG. 18B, the current I_{C} increases when the switch 1834 is turned on and decreases when the switch 1834 is turned off. The current I_{C} has a waveform similar to the current I_{IN} shown in FIG. 14B. Therefore, similar to the discussion in relation to FIG. 14B, the current I_{AC} is substantially in phase with the input voltage V_{AC}. Moreover, the shape of the waveform of the input AC current I_{AC} is similar to the shape of the waveform of the input AC voltage V_{AC}. Therefore, the power factor of the circuit 1800 is corrected to improve the power quality of the circuit 1800. In addition, the waveform of the regulated voltage V_{REG} is more stable than the waveform of the voltage V_{IN}. Thus, the waveform of the output voltage V_{OUT} is not affected by the variations of the input voltage V_{IN}, e.g., a sinusoidal waveform. As a result, ripples of the current I_{OUT} flowing through the light source 1808 caused by variations of the input voltage V_{IN} are reduced or eliminated, which further reduces the line frequency interferences for the light emitted by the light source 1808.

FIG. 20 illustrates an example of the controller 1810, in an embodiment according to the present invention. Elements labeled the same as in FIG. 18A have similar functions. FIG. 20 is described in combination with FIG. 18A.

The controller 1810 includes a signal generator 2050 and a driver 2052. The signal generator 2050 is coupled to the CS pin and the FB pin for receiving the sense signal 1852 and the detection signal 1854, respectively. According to the sense signal 1852 and the detection signal 1854, the signal generator 2050 generates a square wave signal 2062. The driver 2052 provides the driving signal 1850 at the DRV pin to turn the switch 1834 on and off based on the square wave signal 2062, so as to control the output current I_{OUT}.

In one embodiment, the signal generator 2050 includes a sampling circuit 2002, a status detector 2004, and a multiplexer 2006. The sampling circuit 2002 coupled to the CS pin receives the sense signal 1852, and samples the peak level I_{PK} of the current I_{PR} flowing through the primary winding 1824 according to the sense signal 1852. In one embodiment, the sampling circuit 2002 operates as a sample and hold circuit to generate a peak signal V_{PK}. Specifically, the sampling circuit 2002 samples levels of the current I_{PR} and holds the peak level I_{PK} of the current I_{PR} to generate the peak signal V_{PK} proportional to the peak level I_{PK}. In one embodiment, when the current I_{PR} has a peak level I_{PK1} at a first time, the peak signal V_{PK} is maintained at a voltage level V_{PK1} proportional to I_{PK1} until the next peak level of the current I_{PR} occurs at a second time.

In one embodiment, the multiplexer 2006 includes a switch having a first terminal, a second terminal, and a third terminal. The first terminal of the switch 2006 is coupled to the sampling circuit 2002 for receiving the peak signal V_{PK}. The second terminal of the switch 2006 is coupled to the reference ground GND3 for receiving a predetermined signal V_{PRE}, e.g., V_{PRE} is equal to zero volts. The third terminal of the switch 2006 is coupled to the driver 2052 for providing the square wave signal 2062. In an alternative embodiment, the second terminal of the multiplexer 2006 can be coupled to a signal generator that provides a predetermined constant voltage to the second terminal.

In one embodiment, the status detector 2004 is coupled to the FB pin for receiving the detection signal 1854. The status detector 2004 determines whether the transformer 1822 operates in the predetermined state according to the detection signal 1854 and generates a switch control signal 2060 to control the switch 2006. More specifically, in one embodiment, when the detection signal 1854 has the voltage level V₃, which indicates that the transformer 1822 is in the predetermined state, the switch control signal 2060 has a first voltage level, e.g., a high electrical level. Then, the first terminal of the switch 2006 is coupled to the third terminal. Thus, the switch 2006 transfers the peak signal V_{PK} to the driver 2052, and the square wave signal 2062 is equal to the peak signal V_{PK}. When the detection signal 1854 has the voltage level V₄ or V₅, which indicates that the transformer 1822 operates in a state other than the predetermined state, the switch control signal 2060 has a second voltage level, e.g., a low electrical level. Accordingly, the second terminal of the switch 2006 is coupled to the third terminal. Thus, the predetermined signal V_{PRE} is transferred to the driver 2052, and the square wave signal 2062 is equal to the predetermined signal V_{PRE}.

FIG. 21 illustrates waveforms of signals generated or received by the controller 1810, in an embodiment according to the present invention. FIG. 21 is described in combination with FIG. 18A, FIG. 18B and FIG. 20. FIG. 21 shows the square wave signal 2062, the current I_{SE}, the current I_{PR}, the detection signal 1854, and the driving signal 1850.

In the example of FIG. 21, the driving signal 1850 is a PWM signal having a cycle period T_{S}. The driving signal 1850 has a first level, e.g., a high electrical level, during the time period T_{ON}, e.g., a time period from t1 to t2, from t3 to t4, or from t5 to t6. The driving signal 1850 has a second level, e.g., a low electrical level, during a time period T_{OFF}, e.g., a time period from t2 to t3, from t4 to t5, or from t6 to t7.

When the detection signal 1854 has the voltage level V₃ indicating that the transformer 1822 is operating in the predetermined state, the square wave signal 2062 has a voltage equal to the peak signal V_{PK}. Each of the voltages V_{PK} is proportional to the peak level I_{PK} of the current I_{PR}, and can be given by the equation (11):

V_{PK}=A*I_{PK} (11)

where A represents a ratio factor between the peak signal V_{PK} and the peak current I_{PK}. When the detection signal 1854 has the voltage level V₄ or V₅, it indicates that the transformer 1822 operates in a state other than the predetermined state. Thus, the voltage level of the square wave signal 2062 is switched to the level of the predetermined signal V_{PRE}, e.g., zero volts.

The average level I_{SE}_{_{—}}_{AVG} of the current I_{SE} through the secondary winding 1826 during the time period T_{DIS} is proportional to the average level I_{PR}_{_{—}}_{AVG} of the current I_{PR} through the primary winding 1824 during the time period T_{ON}, and can be given by the equation (12):

I_{SE}_{_{—}}_{AVG}=I_{PK}_{_{—}}_{AVG}*(N_{PR}/N_{SE})=½*I_{PK}*(N_{PR}/N_{SE}) (12)

where N_{PR}/N_{SE} represents a turn ratio between the primary winding 1824 and the secondary winding 1826. Furthermore, the average level V_{SQ}_{_{—}}_{AVG} of the square wave signal 2062 can be calculated according to equation (13):

V_{SQ}_{_{—}}_{AVG}=V_{PK}*(T_{DIS}/T_{S}) (13)

Moreover, the average level I_{OUT}_{_{—}}_{AVG} of the output current I_{OUT} is equal to the average level I_{SE}_{_{—}}_{AVG} of the current I_{SE} during the time period T_{S}, and can be given by the equation (14):

I_{OUT}_{_{—}}_{AVG}=I_{SE}_{_{—}}_{AVG}*(T_{DIS}/T_{S}) (14)

Combining the equations (11), (12), (13) and (14), the average level V_{SQ}_{_{—}}_{AVG} of the square wave signal 2062 can be calculated as shown in equation (15):

V_{SQ}_{_{—}}_{AVG}=(2*A/(N_{PR}/N_{SE}))*I_{OUT}_{_{—}}_{AVG} (15)

Therefore, the average level V_{SQ}_{_{—}}_{AVG} of the square wave signal 2062 is proportional to the average output current I_{OUT}_{_{—}}_{AVG} through the LED light source 1808.

Referring to FIG. 20, in one embodiment, the driver 2052 includes an operational amplifier 2012, a sawtooth generator 2014, a comparator 2016, and a buffer 2018. In one embodiment, the operational amplifier 2012 includes an operational transconductance amplifier (OTA) 2020 and a capacitor 2022. The OTA 2020 includes a non-inverting terminal for receiving the square wave signal 2062, and an inverting terminal for receiving a reference signal REF indicating a target level I_{TARGET} for the current I_{OUT}. The OTA 2020 further includes an output terminal for generating a current I₂₀₂₀ according to a difference between the square wave signal 2062 and the reference signal REF, so as to charge or discharge the capacitor 2022. As such, the OTA 2020 generates an error signal 2064. Since the capacitor 2022 filters ripples of the error signal 2064, the error signal 2064 is determined by a difference between the average level V_{SQ}_{_{—}}_{AVG} of the square wave signal 2062 and the reference signal REF. In an alternative embodiment, the capacitor 2022 can be outside the controller 1810 and is coupled to the OTA 2020 through a pin of the controller 1810.

The sawtooth generator 2014 generates a sawtooth signal SAW. The comparator 2016 compares the error signal 2064 and the sawtooth signal SAW to generate the driving signal 1850, e.g., a PWM signal. In the example of FIG. 20, when the average level V_{SQ}_{_{—}}_{AVG} of the square wave signal 2062 increases, the error signal 2064 increases accordingly. The sawtooth signal SAW needs more time to increase to the error signal 2064. Thus, the duty cycle of the driving signal 1850 decreases. Similarly, if the average value V_{SQ}_{_{—}}_{AVG} decreases, the duty cycle of the driving signal 1850 increases.

Referring to both FIG. 18A and FIG. 20, the controller 1810 and the transformer 1822 constitute a negative feedback loop. The average current I_{OUT}_{_{—}}_{AVG} is determined by the duty cycle of the driving signal 1850. Furthermore, the average level V_{SQ}_{_{—}}_{AVG} of the square wave signal 2062 is proportional to the average current I_{OUT}_{_{—}}_{AVG}. Moreover, the duty cycle of the driving signal 1850 is determined by the average level V_{SQ}_{_{—}}_{AVG} of the square wave signal 2062. Therefore, the negative feedback loop including the controller 1810 and the transformer 1822 maintains the average level V_{SQ}_{_{—}}_{AVG} of the square wave signal 2062 to be equal to the reference signal REF. Thus, the average current I_{OUT}_{_{—}}_{AVG} is adjusted to the target current I_{TARGET}.

By way of example, when the average level V_{SQ}_{_{—}}_{AVG} of the square wave signal 2062 is greater than the reference signal REF, it indicates that the average current I_{OUT}_{_{—}}_{AVG} is greater than the target current I_{TARGET}. The amplifier 2012 increases the error signal 2064 to decrease the duty cycle of the driving signal 1850, so as to decrease the average current I_{OUT}_{_{—}}_{AVG} until the average level V_{SQ}_{_{—}}_{AVG} falls to reach the reference signal REF. Similarly, when the average level V_{SQ}_{_{—}}_{AVG} is less than the reference signal REF, it indicates that the average current I_{OUT}_{_{—}}_{AVG} is less than the target level I_{TARGET}. The amplifier 2012 decreases the error signal 2064 to increase the duty cycle of the driving signal 1850, so as to increase the average output current I_{OUT}_{_{—}}_{AVG} until the average level V_{SQ}_{_{—}}_{AVG} of the square wave signal 2062 rises to the reference signal REF. Therefore, the average output current I_{OUT}_{_{—}}_{AVG} is maintained at I_{TARGET}.

As discussed in relation to FIG. 18A, the protection circuit 1836 pulls the voltage at the COMP pin to zero volts, e.g., GND3, if the driving circuit 1800 undergoes an over-current condition. As shown in FIG. 20, the comparator 2016 and the buffer 2018 maintain the switch 1834 off if the COMP pin is maintained at zero volts, so as to cut off both the current I_{C} and the current I_{PR}. The controller 1810 can have other configurations and is not limited to the example shown in FIG. 20.

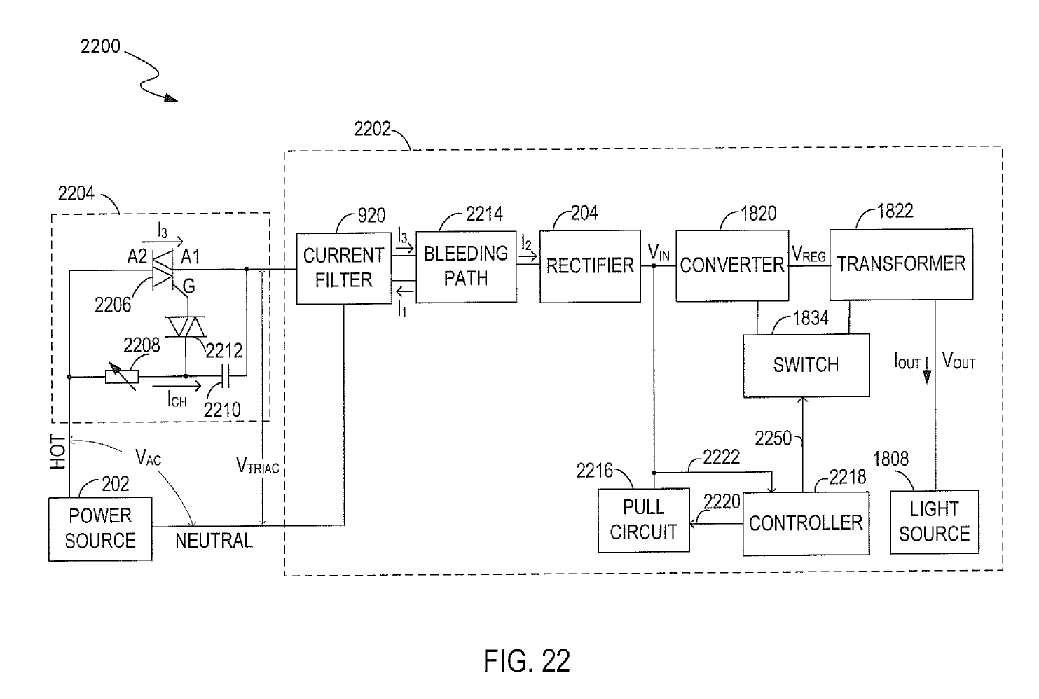

FIG. 22 illustrates a block diagram of an electronic system 2200, in an embodiment according to the present invention. Elements labeled the same as in FIG. 2, FIG. 9A, and FIG. 18A have similar functions. FIG. 22 is described in combination with FIG. 18A.

In the example of FIG. 22, the electronic system 2200 includes a power source 202, a triode for alternating current (TRIAC) dimmer 2204, and a driving circuit 2202. In one embodiment, the driving circuit 2202 includes a current filter 920, a rectifier 204, a converter 1820, a transformer 1822, a switch 1834, a light source 1808, a bleeding path 2214, a pull circuit 2216, and a controller 2218. The power source 202 generates an AC input voltage V_{AC} between a HOT line and a NEUTRAL line. The TRIAC dimmer 2204 converts the AC input voltage V_{AC} to an AC voltage V_{TRIAC} to the rectifier 204. The rectifier 204 receives the AC voltage V_{TRIAC} via the current filter 920 and provides a rectified voltage V_{IN} to the converter 1820. The converter 1820 provides a regulated voltage V_{REG} to the transformer 1822. The transformer 1822 transforms the voltage V_{REG} to an output voltage V_{OUT} to power the light source 1808. The controller 2218 controls an output current I_{OUT} to maintain the brightness of the LED light source 1808 at a target level.

The TRIAC dimmer 2204 can be a push-button switch or a rotary switch mounted on a wall or a light holder. In one embodiment, the TRIAC dimmer 2204 includes a TRIAC component 2206 coupled between the power source 202 and the current filter 920. The TRIAC component 2206 has a terminal A1, a terminal A2, and a gate G. The TRIAC dimmer 2204 further includes an adjustable resistor 2208 coupled in series with a capacitor 2210, and a diode for alternating current (DIAC) component 2212 having one end coupled to the capacitor 2210 and the other end coupled to the gate G of the TRIAC component 2206. The TRIAC component 2206 is a bidirectional switch which can conduct current in either direction when it is triggered. The TRIAC component 2206 can be triggered by a positive or a negative current applied to the gate G. Once triggered, the TRIAC component 2206 continues to conduct until a current through the terminals A1 and A2 drops below a threshold value, e.g., the holding current I_{H}.

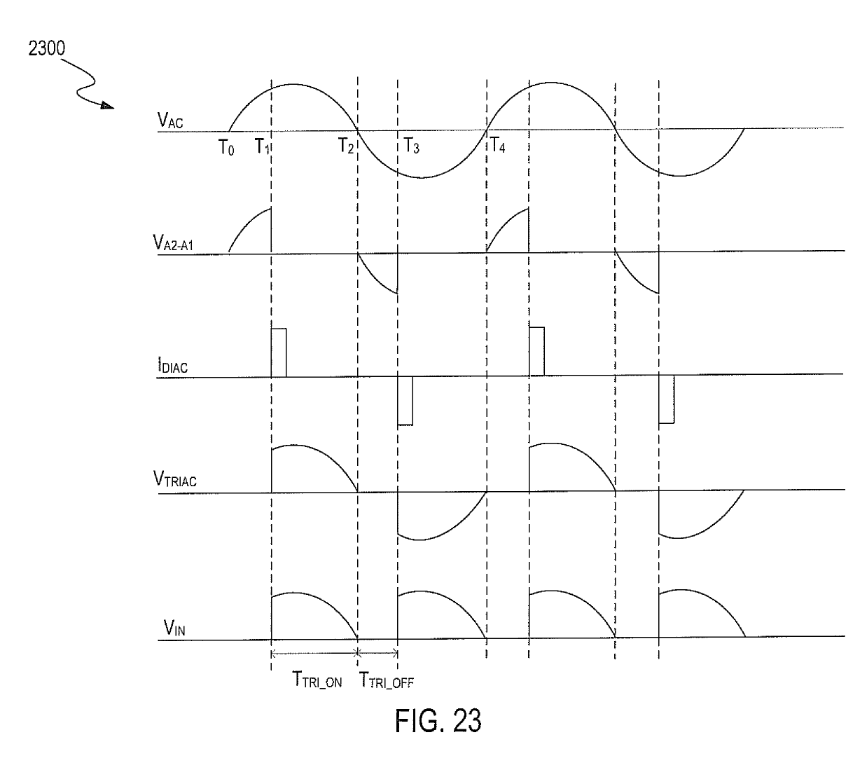

FIG. 23 illustrates a waveform 2300 of signals generated or received by the TRIAC dimmer 2204, in an embodiment according to the present invention. FIG. 23 is described in combination with FIG. 22. FIG. 23 shows the AC input voltage V_{AC}, a voltage V_{A2-A1} between the terminal A1 and terminal A2 of the TRIAC component 2206, a current I_{DIAC} through the DIAC component 2212, the voltage V_{TRIAC}, and the rectified voltage V_{IN}.

In the example of FIG. 23, the AC input voltage V_{AC} has a sinusoidal waveform. When the TRIAC component 2206 is turned off between the times T₀ and T₁, the voltage V_{A2-A1} between the terminal A1 and terminal A2 increases with the AC input voltage V_{AC}. Thus, a charging current I_{CH} flows through the resistor 2208 and the capacitor 2210 to charge the capacitor 2210. Accordingly, the voltage across the capacitor 2210 increases. When the voltage of the capacitor 2210 reaches a voltage threshold at time T₁, the DIAC 2212 is turned on to generate a current pulse applied to the gate G of the TRIAC component 2206. The TRIAC component 2206 is turned on in response to the current pulse. As a result, a current I₁ flows from the HOT line, through the TRIAC component 2206, the current filter 920, and the bleeding path 2214, to the NEUTRAL line. Moreover, a current I₂ flows from the HOT line, through the TRIAC component 2206, to the rectifier 204. Thus, a current I₃ flowing through the TRIAC component 2206 is equal to a sum of the current I₁ and I₂. Between the times T₁ and T₂, the bleeding path 2214 conducts the current I₁ to maintain the current I₃ through the TRIAC component 2206 greater than the holding current I_{H}. Thus, the TRIAC component 2206 remains turned on between the times T₁ and T₂. Therefore, the waveform of the voltage V_{TRIAC} follows that of the input voltage V_{AC} between the times T₁ and T₂.

At time T₂, which is near the end of the first half cycle of the AC input voltage V_{AC}, the TRIAC component 2206 is turned off because the current I₃ through the TRIAC component 2206 falls below the holding current I_{H} of the TRIAC component 2206.

In the second half cycle of the input voltage V_{AC}, the TRIAC component 2206 is turned on again when the voltage across the capacitor 2210 turns on the DIAC component 2212 at time T₃. Similarly, between the times T₃ and T₄, the waveform of the voltage V_{TRIAC} follows that of the input voltage V_{AC}.

In one embodiment, the resistance R₂₂₀₈ of the adjustable resistor 2208 can be adjusted, e.g., by rotating a knob of the TRIAC dimmer 2204. The resistance R₂₂₀₈ of the adjustable resistor 2208 determines the time to turn on the TRIAC component 2206 in each half cycle of the input AC voltage V_{AC}. More specifically, in one embodiment, if the resistance R₂₂₀₈ is increased, the average level of the charging current I_{CH} for charging the capacitor 2210 is decreased after time T₁. As such, the voltage of the capacitor 2210 can take more time to reach the voltage threshold associated with DIAC component 2212. As such, the point in time when the TRIAC component 2206 is turned on is delayed, e.g., it is later than the time T₂. Likewise, if the resistance R₂₂₀₈ is decreased, the point in time when the TRIAC component 2206 is turned on is advanced, e.g., it is earlier than the time T₂. Therefore, by adjusting the resistance R₂₂₀₈, the time at which the TRIAC component 2206 is turned on during each half cycle is shifted, e.g., delayed or advanced, relative to the preceding half cycle. The TRIAC dimmer 2204 can have other configurations, and is not limited to the example shown in FIG. 22 and FIG. 23. In an alternative embodiment, the time at which the TRIAC component 2206 is turned off is shifted during each half cycle if the resistance R₂₂₀₈ is changed, e.g., by a user. In the following descriptions, the TRIAC dimmer 2204 is described as adjusting the time to turn on the TRIAC component 2206 for illustrative purposes; however, this invention is not so limited and is well-suited to a TRIAC dimmer that adjusts the time to turn off a TRIAC component.

In one embodiment, the rectifier 204 can be a bridge rectifier that generates the rectified voltage V_{IN} by remaining positive portions of the AC voltage V_{TRIAC} and converting negative portions of the AC voltage V_{TRIAC} to corresponding positive portions. In some circumstances, the rectified voltage V_{IN} may not decrease to zero volts at the end of a half cycle, because capacitance components in the converter 1820 and the transformer 1822 may store energy to distort the waveform of the rectified voltage V_{IN}. In one embodiment, the controller 2218 compares a monitoring signal 2222, indicating the rectified voltage V_{IN}, and a threshold voltage V_{TH3}, and generates a pull signal 2220 according to a result of the comparison. The pull circuit 2216 pulls the rectified voltage V_{IN} to a predetermined level, e.g., the reference ground GND1, in response to the pull signal 2220. In one embodiment, the rectified voltage V_{IN} can be pulled down at the end of each half cycle, e.g., when the rectified voltage V_{IN} is less than the threshold voltage V_{TH3}. Thus, distortion of the rectified voltage V_{IN} caused by the capacitance components in the converter 1820 and the transformer 1822 can be eliminated or avoided.

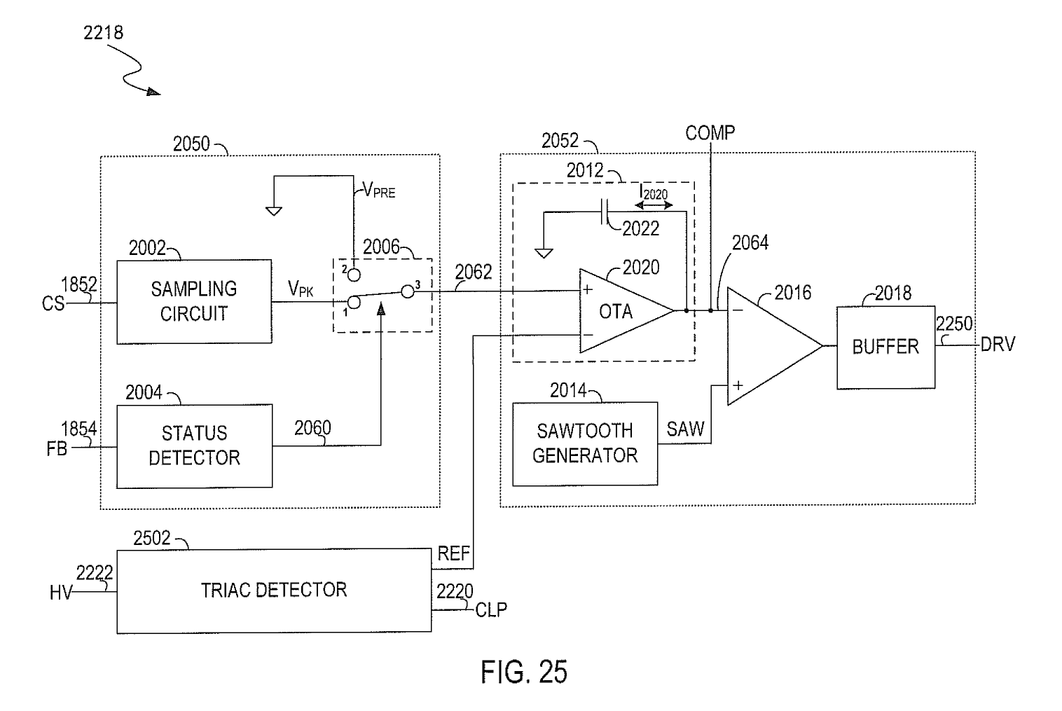

Referring to FIG. 22, the converter 1820, the transformer 1822, and the switch 1834 operate similarly as corresponding components shown in FIG. 18A. Advantageously, the controller 2218 receives the monitoring signal 2222 indicating the rectified voltage V_{IN}, and monitors a conductance status of the TRIAC component 2206 accordingly. The controller 2218 further generates a driving signal 2250 according to the conductance status. The driving signal 2250 switches the switch 1834 between the first state, e.g., the ON state, and the second state, e.g., the OFF state, which further adjusts an average current flowing through the light source 1808. More specifically, based on the monitoring signal 2222, the controller 2218 detects a time point when the TRIAC component 2206 is turned on during each cycle, in one embodiment. If the resistance R₂₂₀₈ is increased, the time to turn on the TRIAC component 2206 is delayed in each cycle period, relative to the preceding half cycle. In response to detecting the delay, the controller 2218 controls the switch 1834 to decrease the average current flowing through the LED light source 1808. Likewise, if the resistance R₂₂₀₈ is decreased, the controller 2218 controls the switch 1834 to increase the average current flowing through the LED light source 1808. Therefore, the dimming control of the LED light source 1808 is achieved in response to the TRIAC dimmer 2204. The operation of the controller 2218 is further described in FIG. 25.

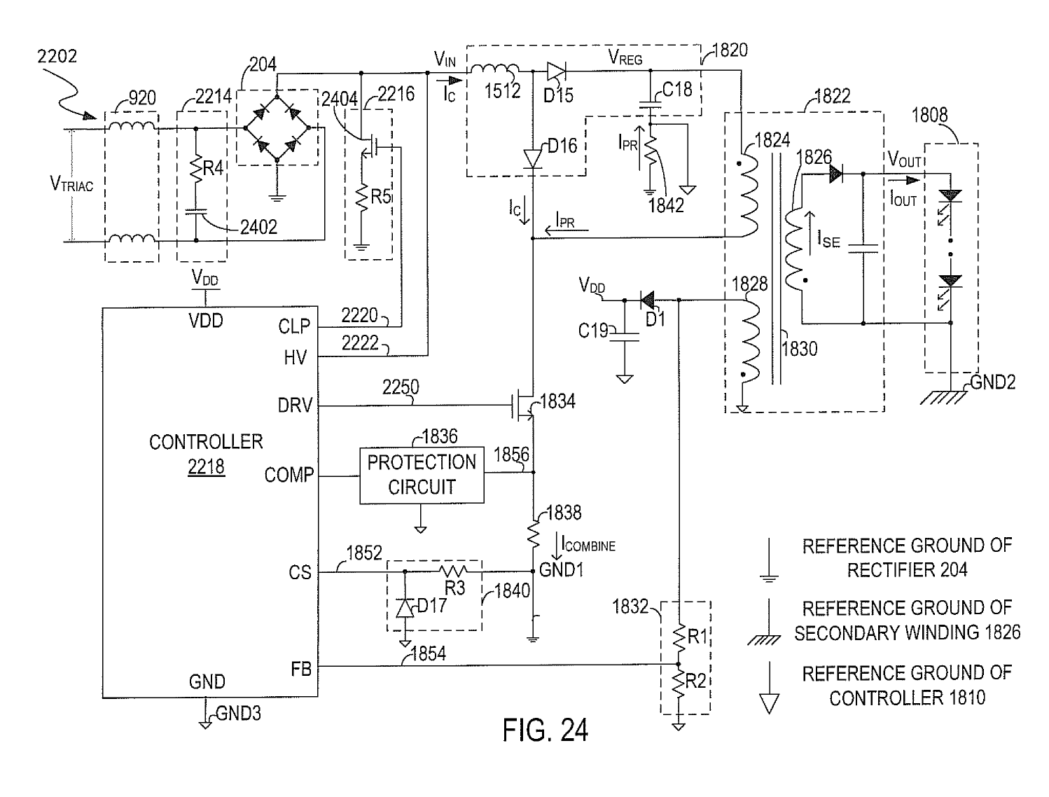

FIG. 24 illustrates an example of the driving circuit 2202, in an embodiment according to the present invention. Elements labeled the same as in FIG. 2, FIG. 9A, FIG. 18A, and FIG. 22 have similar functions. FIG. 24 is described in combination with FIG. 18A and FIG. 22.

The driving circuit 2202 has similar configurations as those of the driving circuit 1800 in FIG. 18A, except for the bleeding path 2214, the pull circuit 2216, and the controller 2218. In one embodiment, the bleeding path 2214 includes a resistor R4 and a capacitor 2402 coupled in series. The pull circuit 2216 includes a switch 2404 and a resistor R5 coupled in series.

The controller 2218 includes multiple pins such as a CLP pin, a HV pin, a DRV pin, a COMP pin, a CS pin, an FB pin, a GND pin, and a VDD pin. In one embodiment, the controller 2218 receives the sense signal 1852 indicating the current I_{PR} via the CS pin, receives the sense signal 1856 indicating the combined current I_{COMBINE} of the current I_{C} and the current I_{PR} via the COMP pin, receives the detection signal 1854 indicating whether the transformer 1822 operates in a predetermined state via the FB pin, receives the monitoring signal 2222 indicating the rectified voltage V_{IN} via the HV pin, generates the driving signal 2250 via the DRV pin, and further generates the pull signal 2220 via the CLP pin.

FIG. 25 illustrates an example of the controller 2218, in an embodiment according to the present invention. Elements labeled the same as in FIG. 20 and FIG. 24 have similar functions. FIG. 25 is described in combination with FIG. 20 and FIG. 24.

In the example of FIG. 25, the controller 2218 includes a signal generator 2050, a TRIAC detector 2502, and a driver 2052 coupled to the signal generator 2050 and the TRIAC detector 2502. The signal generator 2050 generates a detection signal, e.g., the square wave signal 2062, having an average level proportional to an average current I_{OUT}_{_{—}}_{AVG} through the LED light source 1808. The TRIAC detector 2502 generates a reference signal REF indicating a target level for the average current I_{OUT}_{_{—}}_{AVG} according to the monitoring signal 2222. Accordingly, the driver 2052 generates the driving signal 2250 based on the square wave signal 2062 and the reference signal REF. Similar to the discussion in relation to FIG. 20, the signal generator 2050, the driver 2052, and the transformer 1824 constitute a negative feedback loop. The negative feedback loop maintains the average level of the square wave signal 2062 to be equal to the reference signal REF, so as to maintain the average current I_{OUT}_{_{—}}_{AVG} at a target level.

Advantageously, the TRIAC detector 2502 is capable of adjusting the reference signal REF in response to the TRIAC dimmer 2204. More specifically, in one embodiment, if the monitoring signal 2222 indicates that the time to turn on the TRIAC component 2206 is advanced in each cycle, the TRIAC detector 2502 increases the reference signal REF. Thus, the average current I_{OUT}_{_{—}}_{AVG} through the LED light source 1808 is increased. Similarly, if the monitoring signal 2222 indicates that the time to turn on the TRIAC component 2206 is delayed in each cycle, the TRIAC detector 2502 decreases the reference signal REF. Thus, the average current I_{OUT}_{_{—}}_{AVG} through the LED light source 1808 decreases. The controller 2218 can include other components, and is not limited to the example shown in FIG. 25.

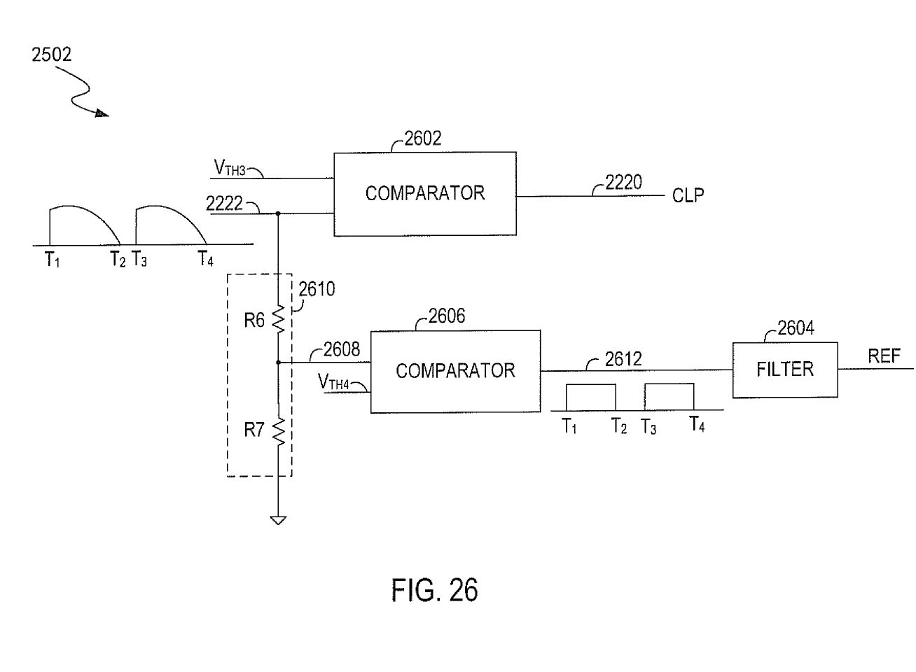

FIG. 26 illustrates an example of the TRIAC detector 2502, in an embodiment according to the present invention. FIG. 26 is described in combination with FIG. 25.

In the example of FIG. 26, the TRIAC detector 2502 includes a comparator 2602, a comparator 2606, a divider 2610, and a filter 2604. In one embodiment, the divider 2610 includes a resistor R6 and a resistor R7 coupled in series. The divider 2610 receives the monitoring signal 2222 and accordingly provides a partial signal 2608 indicating the rectified voltage V_{IN}. The comparator 2606 compares the partial signal 2608 and a threshold voltage V_{TH4}, and generates a square wave signal 2612 according to a result of the comparison. The filter 2604 filters the square wave signal 2612 and generates the reference signal REF.

More specifically, in one embodiment, when the partial signal 2608 is greater than the threshold voltage V_{TH4}, e.g., zero volts, during the time period T_{ON}_{_{—}}_{TRI} between times T₁ and T₂, the square wave signal 2612 is switched to a relatively high electrical level. When the partial signal 2608 is less than the threshold voltage V_{TH4} during the time period T_{OFF}_{_{—}}_{TRI} between times T₂ and T₃, the square wave signal 2612 is switched to a relatively low electrical level. When the time to turn on the TRIAC component 2206 is shifted, the average level of the square wave signal 2612 is changed. The filter 2604 filters the square wave signal 2612 to provide the reference signal REF that is proportional to the average level of the square wave signal 2612. Therefore, the reference signal REF can be changed to adjust the average current I_{OUT}_{_{—}}_{AVG}, which achieves the dimming control of the LED light source 1808 in response to the TRIAC dimmer 2204.

Moreover, the comparator 2602 compares the monitoring signal 2222, indicating the rectified voltage V_{IN}, and the threshold voltage V_{TH3}, to control the pull signal 2220 at the CLP pin. More specifically, in one embodiment, when the monitoring signal 2222 is less than the threshold voltage V_{TH3}, the pull signal 2220 has a high electrical level to turn on the switch 2404. When the monitoring signal 2222 is greater than the threshold voltage V_{TH3}, the pull signal 2220 has a low electrical level to turn off the switch 2404. The TRIAC detector 2502 can have other configurations and is not limited to the example shown in FIG. 26.

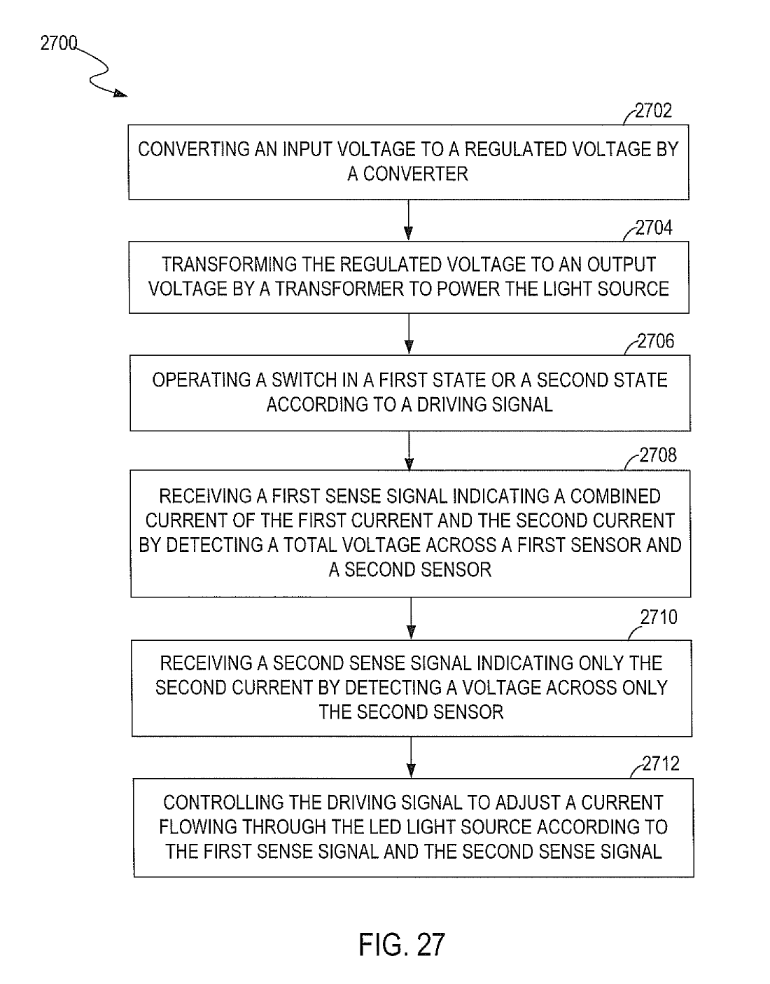

FIG. 27 illustrates a flowchart 2700 of examples of operations performed by a driving circuit, e.g., the driving circuit 1800, in an embodiment according to the present invention. FIG. 27 is described in combination with FIG. 18A to FIG. 26. Although specific steps are disclosed in FIG. 27, such steps are examples. That is, the present invention is well suited to performing various other steps or variations of the steps recited in FIG. 27.

In block 2702, an input voltage, e.g., the input voltage V_{IN}, is converted to a regulated voltage, e.g., the voltage V_{REG}, by a converter, e.g, the converter 1820.

In block 2704, the regulated voltage is transformed to an output voltage, e.g., the voltage V_{OUT}, by a transformer, e.g., the transformer 1822, to power an LED light source, e.g., the LED light source 1808.

In block 2706, a switch, e.g., the switch 1834, is operated in a first state, e.g., an ON state, or a second state, e.g., an OFF state, according to a driving signal, e.g. the driving signal 1850. Both a first current through the converter, e.g., the current I_{C}, and a second current through the transformer, e.g., the current I_{PR}, further flow through the switch when the switch operates in the first state. In one embodiment, the transformer includes a primary winding, e.g., the primary winding 1824, and a secondary winding, e.g., the secondary winding 1826. The second current flowing through the primary winding increases during the first state of the switch. A third current flowing through the secondary winding, e.g., the current I_{SE}, decreases until reaching a predetermined level during the second state of the switch. In one embodiment, it is determined that the transformer operates in a predetermined state when the third current decrease during the second state of the switch, e.g., during the time period T_{DIS}.

In block 2708, a first sense signal, e.g., the sense signal 1856, indicating a combined current of the first current and the second current, e.g., the current I_{COMBINE}, is received by detecting a total voltage across a first sensor, e.g., the resistor 1838, and a second sensor, e.g., the resistor 1842. The first sensor is coupled between the switch and a first reference node, and the second sensor is coupled between the first reference node and a second reference node. In one embodiment, the first reference node is a reference ground of a rectifier that generates the input voltage. The second reference node is a reference ground of a controller that performs the step of controlling the driving signal.

In block 2710, a second sense signal, e.g., the sense signal 1852, indicating only the second current, is received by detecting a voltage across only the second sensor. In one embodiment, a square wave signal, e.g., the square wave signal 2062, is provided based on the second sense signal. The square wave signal has an average voltage level proportional to an average current flowing through the LED light source. In one embodiment, the square wave signal is adjusted to a first level proportional to a peak level of the second current, e.g., the voltage V_{PK}, when the transformer operates in the predetermined state. The square wave signal is adjusted to a second level, e.g., the voltage V_{PRE}, if the transformer operates in a state other than the predetermined state.

In block 2712, the driving signal is controlled to adjust a current flowing through the LED light source according to the first sense signal and the second sense signal. In one embodiment, the driving signal is controlled based on the square wave signal to adjust the average current to a target level. In one embodiment, the first sense signal is compared to a threshold, e.g., V_{TH2}, and a voltage on a pin of a controller is pulled to a predetermined level according to a result of the comparison. The driving signal is controlled to maintain the switch at the second state if the voltage on the pin is pulled to the predetermined level. In one embodiment, an AC voltage, e.g., the voltage V_{TRIAC}, is converted to the input voltage by a TRIAC component, e.g., the TRIAC component 2206. A conductance status of the TRIAC component is monitored according to a monitoring signal indicating the input voltage, e.g., the monitoring signal 2222. A reference signal indicating a target level for an average current through the LED light source, e.g., the reference signal REF, is generated according to the monitoring signal. The driving signal is controlled according the reference signal to switch the switch between the first state and the second state to control dimming of the LED light source. In one embodiment, the time to turn on the TRIAC component in each cycle of the AC voltage is monitored according to the monitoring signal. The reference signal is generated according to the time.

Embodiments in accordance with the present invention provide a driving circuit for driving a load, e.g., an LED light source. In one embodiment, the driving circuit includes a converter, a transformer, a first sensor, and a second sensor. The converter receives an input voltage and provides a regulated voltage. The transformer transforms the regulated voltage to an output voltage to power the LED light source. Both a first current through the converter and a second current through the transformer further flow through the switch when a switch operates in a first state. The first sensor coupled between the switch and a first reference node provides a first sense signal indicating a combined current of the first current and the second current. The second sensor coupled between the first reference node and a second reference node provides a second sense signal indicating only the second current. Advantageously, due to the innovative electronic connections among the switch, the first reference ground, the second reference ground, and the first and second sensors, the second sense signal indicating only the second current through the transformer is provided even if the first current and the second current both flow through the switch. For a circuit having different reference grounds in a primary side and a secondary side, a sensor (coupled to circuitry in the secondary side of the circuit) and an isolator (coupled between circuitry in the secondary side and that in the primary side of the circuit) are both removed, which reduces the size and the cost of the circuit.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A driving circuit for powering a light-emitting diode (LED) light source, said driving circuit comprising:
a converter coupled to a switch operable in a first state and operable in a second state, and configured to receive an input voltage and provide a regulated voltage;
a transformer coupled to said converter and said switch, and configured to transform said regulated voltage to an output voltage to power said LED light source, wherein both a first current through said converter and a second current through said transformer further flow through said switch when said switch operates in said first state;
a first sensor coupled between said switch and a first reference node, and configured to provide a first sense signal indicating a combined current of said first current and said second current; and
a second sensor coupled between said first reference node and a second reference node, and configured to provide a second sense signal indicating only said second current.

2. The driving circuit as claimed in claim 1, further comprising:
a controller coupled to said switch and configured to generate a driving signal to switch said switch between said first state and said second state; and
a protection circuit coupled to a pin of said controller and configured to receive said first sense signal, compare said first sense signal to a threshold, and pull a voltage of said pin to a predetermined level according to a result of said comparison.

3. The driving circuit as claimed in claim 2, wherein said controller controls said driving signal to maintain said switch at said second state if said voltage of said pin is maintained at said predetermined level.

4. The driving circuit as claimed in claim 1, wherein when said switch operates in said first state, both said first current and said second current flow through said first sensor, and only said second current flows through said second sensor.

5. The driving circuit as claimed in claim 1, wherein said first reference node is further coupled to a current path for said first current, wherein said first current flows through said current path other than said second sensor.

6. The driving circuit as claimed in claim 1, wherein said first sense signal has a voltage equal to a sum of a voltage across said first sensor and a voltage across said second sensor, and wherein said second sense signal has a voltage equal to said voltage across said second sensor.

7. The driving circuit as claimed in claim 1, further comprising:
a rectifier that provides said input voltage; and
a controller that generates a driving signal to switch said switch between said first state and said second state, wherein said rectifier and said controller have different reference grounds, and wherein said first reference node is a reference ground of said rectifier, and wherein said second reference node is a reference ground of said controller.

8. The driving circuit as claimed in claim 1, further comprising:
a controller coupled to said switch and configured to generate a driving signal to switch said switch between said first state and said second state, said controller further comprising a pin for receiving said second sense signal; and
a clamp circuit coupled between said first reference node and said pin, and configured to clamp a voltage at said pin to a predetermined level if said voltage across said second sensor drops below a predetermined threshold.

9. The driving circuit as claimed in claim 1, further comprising:
a controller coupled to said switch, and configured to provide a square wave signal based on said second sense signal, said square wave signal having an average level proportional to an average current flowing through said LED light source, and further configured to provide a driving signal based on said square wave signal to control said switch so as to control said average current.

10. The circuit as claimed in claim 9, wherein said square wave signal has a first voltage level proportional to a peak level of said second current when said transformer operates in a predetermined state, wherein said square wave signal has a second voltage level if said transformer operates in a state other than said predetermined state.

11. The circuit as claimed in claim 10, wherein said transformer comprises a primary winding and a secondary winding, wherein said second current flowing through said primary winding increases during said first state of said switch, and a third current flowing through said secondary winding decreases during said second state of said switch, and wherein said transformer operates in said predetermined state during a time period when said third current through said secondary winding decreases.

12. The circuit as claimed in claim 9, wherein said controller comprises:
a driver configured to generate said driving signal to control said switch;
a sampling circuit configured to sample a peak level of said second current according to said second sense signal and generate a peak signal having a first level proportional to said peak level; and
a multiplexer configured to transfer said peak signal to said driver if said transformer operates in said predetermined state, and otherwise transfer a predetermined signal having a second level to said driver.

13. The circuit as claimed in claim 9, wherein said controller and said transformer constitute a negative feedback loop, wherein said negative feedback loop maintains an average voltage of said square wave signal to be equal to a reference signal, so as to maintain an average current flow through said LED light source at a target level.

14. The circuit as claimed in claim 1, wherein a triode for alternating current (TRIAC) component receives an alternating current (AC) voltage, and is turned on and off during each cycle of said AC voltage to generate said input voltage, wherein said circuit further comprises:
a controller configured to receive a monitoring signal indicating said input voltage, monitor a conductance status of said TRIAC component according to said monitoring signal, and generate a driving signal according to said conductance status, said driving signal switching said switch between said first state and said second state to control dimming of said LED light source.

15. The circuit as claimed in claim 14, wherein said controller further comprises:
a signal generator configured to generate a detection signal having an average level proportional to an average current flowing through said LED light source;
a TRIAC detector configured to generate a reference signal according to said monitoring signal, said reference signal indicating a target level for said average current through said LED light source; and
a driver coupled to said signal generator and said TRIAC detector, and configured to generate said driving signal based on said detection signal and said reference signal so as to control said switch to adjust said average current to said target level.

16. The circuit as claimed in claim 15, wherein said TRIAC detector monitors a time to turn on said TRIAC component in each cycle of said AC voltage according to said monitoring signal, and generates said reference signal according to said time.

17. The circuit as claimed in claim 15, wherein said TRIAC detector generates a square wave signal according to said monitoring signal, and filters said square wave signal to generate said reference signal indicating an average level of said square wave signal.

18. A controller for controlling power to a light-emitting diode (LED) light source, said controller comprising:
an output pin configured to generate a driving signal to operate a switch, wherein a converter converts an input voltage to a regulated voltage based on operations of said switch, and wherein a transformer transforms said regulated voltage to an output voltage based on said operations to power said LED light source, wherein both a first current through said converter and a second current through said transformer further flow through said switch when said switch operates in a first state;
a protection pin coupled to a protection circuit, wherein said protection circuit senses a combined current of said first current and said second current by detecting a total voltage across a first resistor and a second resistor, wherein said first resistor is coupled between said switch and a first reference node, and said second resistor is coupled between said first reference node and a second reference node; and
a sense pin coupled to said first reference node, and configured to sense only said second current by detecting a voltage across said second resistor,
wherein said controller controls said driving signal according to signals on said sense pin and said protection pin.

19. The controller as claimed in claim 18, wherein said controller further comprises:
a feedback pin coupled to an auxiliary winding of said transformer, wherein a signal received by said feedback pin indicates whether said transformer operates in a predetermined state, and wherein said controller generates a square wave signal having an average level proportional to an average current flowing through said LED light source based on signals on said sense pin and said feedback pin.

20. The controller as claimed in claim 19, wherein said square wave signal has a first level proportional to a peak level of said second current when said transformer operates in said predetermined state, and wherein said square wave signal has a second level if said transformer operates in a state other than said predetermined state.

21. The controller as claimed in claim 19, wherein said transformer comprises a primary winding and a secondary winding, wherein said second current flowing through said primary winding increases when said switch operates in said first state, and a third current flowing through said secondary winding decreases when said switch operates in a second state, and wherein said transformer operates in said predetermined state during a time period when said third current through said secondary winding decreases.

22. The controller as claimed in claim 18, wherein said protection circuit pulls a voltage at said protection pin to a predetermined level if said total voltage across said first and second resistors is greater than a threshold, and wherein said controller controls said driving signal to maintain said switch in a second state if said voltage at said protection pin is pulled to said predetermined level.

23. The controller as claimed in claim 18, wherein said first reference node is a reference ground of a rectifier that generates said input voltage, and wherein said second reference node is a reference ground of said controller.

24. The controller as claimed in claim 18, wherein a triode for alternating current (TRIAC) component converts an alternating current (AC) voltage to said input voltage, wherein said controller further comprises:
a monitoring pin configured to receive a monitoring signal indicating said input voltage, wherein said controller monitors a conductance status of said TRIAC component according to said monitoring signal, and controls said driving signal according to said conductance status to control dimming of said LED light source.

25. The controller as claimed in claim 24, further comprising:
a signal generator configured to generate a detection signal having an average level proportional to an average current flowing through said LED light source;
a TRIAC detector configured to generate a reference signal according to said monitoring signal, said reference signal indicating a target level for said average current through said LED light source; and
a driver configured to generate said driving signal based on said detection signal and said reference signal so as to control said switch to adjust said average current to said target level.

26. The controller as claimed in claim 25, wherein said controller monitors a time to turn on said TRIAC component in each cycle of said AC voltage according to said monitoring signal, and generates said reference signal according to said time.

27. A method for controlling power to a light-emitting diode (LED) light source, said method comprising:
converting an input voltage to a regulated voltage by a converter;
transforming said regulated voltage to an output voltage by a transformer to power said LED light source;
operating a switch according to a driving signal, wherein both a first current through said converter and a second current through said transformer further flow through said switch when said switch operates in a first state;
receiving a first sense signal indicating a combined current of said first current and said second current by detecting a total voltage across a first sensor and a second sensor, wherein said first sensor is coupled between said switch and a first reference node, and wherein said second sensor is coupled between said first reference node and a second reference node;
receiving a second sense signal indicating only said second current by detecting a voltage across only said second sensor; and
controlling said driving signal to adjust a current flowing through said LED light source according to said first sense signal and said second sense signal.

28. The method as claimed in claim 27, further comprising:
providing a square wave signal based on said second sense signal, wherein said square wave signal has an average level proportional to an average current flowing through said LED light source; and
controlling said driving signal based on said square wave signal to adjust said average current to a target level.

29. The method as claimed in claim 28, further comprising:
adjusting said square wave signal to a first level proportional to a peak level of said second current when said transformer operates in a predetermined state; and
adjusting said square wave signal to a second constant level if said transformer operates in a state other than said predetermined state.

30. The method as claimed in claim 29, wherein said transformer includes a primary winding and a secondary winding, wherein said second current flowing through said primary winding increases during said first state of said switch, wherein a third current flowing through said secondary winding decreases until reaching a predetermined level during a second state of said switch, wherein said method further comprises:
determining that said transformer operates in said predetermined state when said third current decreases during said second state of said switch.

31. The method as claimed in claim 27, wherein said first reference node is a reference ground of a rectifier that generates said input voltage, and wherein said second reference node is a reference ground of a controller that performs the step of controlling said driving signal.

32. The method as claimed in claim 27, further comprising:
comparing said first sense signal to a threshold;
pulling a voltage on a pin of a controller to a predetermined level according to a result of said comparison; and
controlling said driving signal to maintain said switch at said second state if said voltage on said pin is pulled to said predetermined level.

33. The method as claimed in claim 27, further comprising:
converting an alternating current (AC) voltage to said input voltage by a triode for alternating current (TRIAC) component;
monitoring a conductance status of said TRIAC component according to a monitoring signal indicating said input voltage;
generating a reference signal indicating a target level for an average current through said LED light source according to said monitoring signal; and controlling said driving signal according to said reference signal to switch said switch between said first state and said second state to control dimming of said LED light source.

34. The method as claimed in claim 33, further comprising:
monitoring a time to turn on said TRIAC component in each cycle of said AC voltage according to said monitoring signal; and
generating said reference signal according to said time.
